(19) United States
(12) Patent Application Publication
(10) Pub. No.: US 2025/0096310 A1
(43) Pub. Date: Mar. 20, 2025

(54) Lithium-Based Solid-State Electrolyte with Lithium Ions Exchanged by Ions Having a Larger Ionic Radius

(71) Applicant: Brown University, Providence, RI (US)

(72) Inventors: Brian W. Sheldon, Brookline, MA (US); Yue Qi, Providence, RI (US); Sydney Morris, Merrimack, NH (US); Harsh D. Jagad, Providence, RI (US); Stephen J. Harris, Walnut Creek, CA (US)

(21) Appl. No.: 18/884,537

(22) Filed: Sep. 13, 2024

Related U.S. Application Data
(60) Provisional application No. 63/539,013, filed on Sep. 18, 2023.

(51) Int. Cl. H01M 10/0562; H01M 10/054

(52) U.S. Cl. CPC H01M 10/0562; H01M 10/054

(57) ABSTRACT

The present disclosure describes a method of providing residual compressive stress to a lithium-based solid electrolyte by ion exchanging lithium ions with ions having a larger ionic radius that the lithium ions.

### RELATED APPLICATIONS

This application claims the benefit of U.S. Provisional Application No. 63/539,013 and filed Sep. 18, 2023 which is hereby incorporated by reference in its entirety.

### FEDERALLY SPONSORED RESEARCH AND DEVELOPMENT

This invention was made with government support under grant numbers 2054441 and 1832829 awarded by the National Science Foundation and Contract Nos. DE-AC02-05CH11231 and DE-AC03-76SF00098 awarded by the U.S. Department of Energy. The government has certain rights in the invention.

### TECHNICAL FIELD

The present disclosure relates to lithium-based solid state electrolytes for use in solid state lithium metal anode batteries, and to solid-state lithium metal anode batteries including such lithium-based solid state electrolytes.

### DESCRIPTION OF RELATED ART

All solid-state batteries (ASSB) are important to commercializing lithium metal anode technology for secondary batteries, with a substantial increase in energy density. However, the low critical current densities for lithium metal batteries are impeding progress, [see Sharafi, A.; Meyer, H. M.; Nanda, J.; Wolfenstine, J.; Sakamoto, J., Characterizing the Li—Li₇La₃Zr₂O₁₂ interface stability and kinetics as a function of temperature and current density. Journal of Power Sources 2016, 302, 135-139; Lu, Y.; Zhao, C. Z.; Yuan, H.; Cheng, X. B.; Huang, J. Q.; Zhang, Q., Critical Current Density in Solid-State Lithium Metal Batteries: Mechanism, Influences, and Strategies. Advanced Functional Materials 2021, 31 (18), 2009925; Kasemchainan, J.; Zekoll, S.; Spencer Jolly, D.; Ning, Z.; Hartley, G. O.; Marrow, J.; Bruce, P. G., Critical stripping current leads to dendrite formation on plating in lithium anode solid electrolyte cells. Nat Mater 2019, 18 (10), 1105-1111]since most existing reported critical current densities (CCDs) [see Lu, Y.; Zhao, C. Z.; Yuan, H.; Cheng, X. B.; Huang, J. Q.; Zhang, Q., Critical Current Density in Solid-State Lithium Metal Batteries: Mechanism, Influences, and Strategies. Advanced Functional Materials 2021, 31 (18), 2009925; Krauskopf, T.; Hartmann, H.; Zeier, W. G.; Janek, J., Toward a Fundamental Understanding of the Lithium Metal Anode in Solid-State Batteries—An Electrochemo-Mechanical Study on the Garnet-Type Solid Electrolyte Li_{6.25}Al_{0.25}La₃Zr₂O₁₂. ACS Appl Mater Interfaces 2019, 11 (15), 14463-14477] are still much lower than a commercially required CCD of at least 3 mA/cm² [see Flatscher, F.; Philipp, M.; Ganschow, S.; Wilkening, H. M. R.; Rettenwander, D., The natural critical current density limit for Li₇La₃Zr₂O₁₂ garnets. Journal of Materials Chemistry A 2020, 8 (31), 15782-15788]. The principal failure mechanism of these ASSBs is the growth and propagation of lithium filaments, which are sometimes referred to as dendrites.” [See Sharafi, A.; Haslam, C. G.; Kerns, R. D.; Wolfenstine, J.; Sakamoto, J., Controlling and correlating the effect of grain size with the mechanical and electrochemical properties of Li₇La₃Zr₂O₁₂ solid-state electrolyte. J. Mater. Chem. A 2017, 5 (40), 21491-21504; Wang, M. J.; Choudhury, R.; Sakamoto, J., Characterizing the Li-Solid-Electrolyte Interface Dynamics as a Function of Stack Pressure and Current Density. Joule 2019, 3 (9), 2165-2178; Liu, H.; Cheng, X.-B.; Huang, J.-Q.; Yuan, H.; Lu, Y.; Yan, C.; Zhu, G.-L.; Xu, R.; Zhao, C.-Z.; Hou, L.-P.; He, C.; Kaskel, S.; Zhang, Q., Controlling Dendrite Growth in Solid-State Electrolytes. ACS Energy Letters 2020, 5 (3), 833-843; Tu, Q.; Barroso-Luque, L.; Shi, T.; Ceder, G., Electrodeposition and Mechanical Stability at Lithium-Solid Electrolyte Interface during Plating in Solid-State Batteries. Cell Reports Physical Science 2020, 1 (7), 100106].

Lithium filaments can penetrate even stiff electrolytes [see Liu, H.; Cheng, X.-B.; Huang, J.-Q.; Yuan, H.; Lu, Y.; Yan, C.; Zhu, G.-L.; Xu, R.; Zhao, C.-Z.; Hou, L.-P.; He, C.; Kaskel, S.; Zhang, Q., Controlling Dendrite Growth in Solid-State Electrolytes. ACS Energy Letters 2020, 5 (3), 833-843; Hatzell, K. B.; Chen, X. C.; Cobb, C. L.; Dasgupta, N. P.; Dixit, M. B.; Marbella, L. E.; McDowell, M. T.; Mukherjee, P. P.; Verma, A.; Viswanathan, V.; Westover, A. S.; Zeier, W. G., Challenges in Lithium Metal Anodes for Solid-State Batteries. ACS Energy Letters 2020, 5 (3), 922-934]. It has been suggested that this penetration is due to defects in the solid electrolytes and pre-existing or generated tensile stresses at the crack tip [see Tu, Q.; Barroso-Luque, L.; Shi, T.; Ceder, G., Electrodeposition and Mechanical Stability at Lithium-Solid Electrolyte Interface during Plating in Solid-State Batteries. Cell Reports Physical Science 2020, 1 (7), 100106; LePage, W. S.; Chen, Y.; Kazyak, E.; Chen, K.-H.; Sanchez, A. J.; Poli, A.; Arruda, E. M.; Thouless, M. D.; Dasgupta, N. P., Lithium Mechanics: Roles of Strain Rate and Temperature and Implications for Lithium Metal Batteries. Journal of The Electrochemical Society 2019, 166 (2), A89-A97; Klinsmann, M.; Hildebrand, F. E.; Ganser, M.; McMeeking, R. M., Dendritic cracking in solid electrolytes driven by lithium insertion. Journal of Power Sources 2019, 442, 227226; Barai, P.; Ngo, A. T.; Narayanan, B.; Higa, K.; Curtiss, L. A.; Srinivasan, V., The Role of Local Inhomogeneities on Dendrite Growth in LLZO-Based Solid Electrolytes. Journal of The Electrochemical Society 2020, 167 (10), 100537]. This tensile stress assists crack propagation and can permit lithium filament growth even at minor overpotentials (˜10 mV) [see Tu, Q.; Barroso-Luque, L.; Shi, T.; Ceder, G., Electrodeposition and Mechanical Stability at Lithium-Solid Electrolyte Interface during Plating in Solid-State Batteries. Cell Reports Physical Science 2020, 1 (7), 100106; Porz, L.; Swamy, T.; Sheldon, B. W.; Rettenwander, D.; Frömling, T.; Thaman, H. L.; Berendts, S.; Uecker, R.; Carter, W. C.; Chiang, Y. M., Mechanism of Lithium Metal Penetration through Inorganic Solid Electrolytes. Advanced Energy Materials 2017, 7 (20), 1701003]. Lithium filament growth is mechanically coupled to the crack growth in solid electrolytes, although the tip of the lithium filament may lag behind the crack tip [see Zhao, J.; Tang, Y.; Dai, Q.; Du, C.; Zhang, Y.; Xue, D.; Chen, T.; Chen, J.; Wang, B.; Yao, J.; Zhao, N.; Li, Y.; Xia, S.; Guo, X.; Harris, S. J.; Zhang, L.; Zhang, S.; Zhu, T.; Huang, J., In situ Observation of Li Deposition-Induced Cracking in Garnet Solid Electrolytes. Energy & Environmental Materials 2021, 5, 524-532; Ning, Z.; Jolly, D. S.; Li, G.; De Meyere, R.; Pu, S. D.; Chen, Y.; Kasemchainan, J.; Ihli, J.; Gong, C.; Liu, B.; Melvin, D. L. R.; Bonnin, A.; Magdysyuk, O.; Adamson, P.; Hartley, G. O.; Monroe, C. W.; Marrow, T. J.; Bruce, P. G., Visualizing plating-induced cracking in lithium-anode solid-electrolyte cells. Nat Mater 2021, 20 (8), 1121-1129].

Applications of residual compressive stresses (RCS) in the sub-surface region [see Mochizuki, M., Control of welding residual stress for ensuring integrity against fatigue and stress-corrosion cracking. See Nuclear Engineering and Design 2007, 237 (2), 107-123; M. Kobayashi, T. M. a. Y. M., Mechanism of creation of compressive residual stress by shot peening. Int. J. Fatigue 1998, 20, 351-357; S. A. Meguid, G. S., J. C. Stranart, J. Daly, Three-dimensional dynamic [symbol] nite element analysis of shot-peening induced residual stresses. Finite Elements in Analysis and Design 1999, 31, 179-191] have been demonstrated to prevent crack growth in a myriad of systems ranging from steel [see Huber, A.; Beedle, L. Residual stress and the compressive strength of steel; Lehigh University Bethlehem PA, Fritz Engineering Lab: 1953; Totten, G. E., Handbook of residual stress and deformation of steel. ASM international: 2002; Takakuwa, O.; Soyama, H., Effect of residual stress on the corrosion behavior of austenitic stainless steel. Advances in chemical engineering and science 2014, 5 (01), 62] to glasses [see Martin E. Nordberg, E. M., Harmon M. Garfinkel, and Joseph S. Olcott, Strengthening by Ion Exchange. Journal of The American Ceramic Society 47 (5), 215-219; Ajit Y. Sane, A. P. C., Stress Buildup and Relaxation During Ion Exchange Strengthening of Glass. J. Am. Cerum. Soc. 1984, 70, 86-89; Gy, R., Ion exchange for glass strengthening. Materials Science and Engineering: B 2008, 149 (2), 159-165]. The RCS approach should not be confused with the stack pressure applied to the battery cells. Stack pressure is a stress induced by an external load which has been shown to mitigate the dendrite penetration problem [see Wang, M. J.; Choudhury, R.; Sakamoto, J., Characterizing the Li-Solid-Electrolyte Interface Dynamics as a Function of Stack Pressure and Current Density. Joule 2019, 3 (9), 2165-2178; Tu, Q.; Barroso-Luque, L.; Shi, T.; Ceder, G., Electrodeposition and Mechanical Stability at Lithium-Solid Electrolyte Interface during Plating in Solid-State Batteries. Cell Reports Physical Science 2020, 1 (7), 100106] by increasing interface contact area and causing a more uniform current distribution. On the other hand, residual stresses are the stresses that remain in a sample after any external mechanical loads are removed.

To some extent, filament growth in ASSBs may be analogous to stress assisted corrosion (SAC) cracking reported in many systems [see Kim, K.; Luo, H.; Singh, A. K.; Zhu, T.; Graham, S.; Pierron, O. N., Environmentally Assisted Cracking in Silicon Nitride Barrier Films on Poly(ethylene terephthalate) Substrates. ACS Appl Mater Interfaces 2016, 8 (40), 27169-27178; Wiederhorn, S. M., Moisture Assisted Crack Growth In Ceramics. The International Journal of Fracture Mechanics 1968, 4 (June), 171-177; S. M. Wiederhorn, E. R. F., Jr. and R. M. Thomson, Micromechanisms of Crack Growth in Ceramics and Glasses in Corrosive Environments. Navy, D. o. t., Ed. National Bureau of Standards: Arlington, VA, 1980; Vol. NBSIR 80-2023], where a soft material (typically water) penetrates through a hard material (typically steel). For example, in the case of boiler tubes, a corrosive environment (e.g. dissolved oxygen and moisture) together with a residual tensile stress (e.g. induced by welding, etc.) is well known to cause mechanical failure [see Singh, P. M.; Mahmood, J., Stress Assisted Corrosion of Waterwall Tubes in Recovery Boiler Tubes: Failure Analysis. Journal of Failure Analysis and Prevention 2007, 7 (5), 361-370]. In the case of ASSBs, the role of the corrosive environment might be played by the excess electrons and lithium reduction at the interface [see Tian, H.-K.; Xu, B.; Qi, Y., Computational study of lithium nucleation tendency in Li₇La₃Zr₂O₁₂ (LLZO) and rational design of interlayer materials to prevent lithium dendrites. Journal of Power Sources 2018, 392, 79-86]. Reduced lithium atoms can trigger a myriad of electrolyte decomposition products of the solid electrolyte (tetragonal-LLZO, Li₃P, Li₂O, Li₂CO₃, etc.) [See Rettenwander, D.; Wagner, R.; Reyer, A.; Bonta, M.; Cheng, L.; Doeff, M. M.; Limbeck, A.; Wilkening, M.; Amthauer, G., Interface Instability of Fe-Stabilized Li₇La₃Zr₂O₁₂ versus Li Metal. J Phys Chem C Nanomater Interfaces 2018, 122 (7), 3780-3785; Schwöbel, A.; Hausbrand, R.; Jaegermann, W., Interface reactions between LiPON and lithium studied by in-situ X-ray photoemission. Solid State Ionics 2015, 273, 51-54; Zhu, Y.; He, X.; Mo, Y., Origin of Outstanding Stability in the Lithium Solid Electrolyte Materials: Insights from Thermodynamic Analyses Based on First-Principles Calculations. ACS Appl Mater Interfaces 2015, 7 (42), 23685-93; Gao, J.; Guo, X.; Li, Y.; Ma, Z.; Guo, X.; Li, H.; Zhu, Y.; Zhou, W., The Ab Initio Calculations on the Areal Specific Resistance of Li-Metal/Li₇La₃Zr₂O₁₂ Interphase. Advanced Theory and Simulations 2019, 2, 1900028]. The molar volume change due to solid electrolyte decomposition reactions can cause as much as 20% volume reduction [see Tian, H.-K.; Chakraborty, A.; Talin, A. A.; Eisenlohr, P.; Qi, Y., Evaluation of the electrochemo-mechanically induced stress in all-solid-state Li-ion batteries. Journal of The Electrochemical Society 2020, 167 (9), 090541], and hence can induce tensile stresses in the nearby region. In the case of SAC cracking, application of residual compressive stress has been shown to ameliorate the problem because they inhibit crack growth [see Zhao, X.; Munroe, P.; Habibi, D.; Xie, Z., Roles of compressive residual stress in enhancing the corrosion resistance of nano nitride composite coatings on steel. Journal of Asian Ceramic Societies 2018, 1 (1), 86-94; Al-Obaid, Y., The effect of shot peening on stress corrosion cracking behaviour of 2205-duplex stainless steel. Engineering Fracture Mechanics 1995, 51 (1), 19-25].

Ion-exchange (IX) [see Qi, Y.; Ban, C.; Harris, S. J., A New General Paradigm for Understanding and Preventing Li Metal Penetration through Solid Electrolytes. Joule 2020, 4 (12), 2599-2608] is one of the methods to introduce such surface compressive stresses by substituting a smaller ion with a bigger ion for a system that is constrained mechanically (i.e. not allowed to geometrically relax). This approach is in commercial use by Corning in GORILLA GLASS [Corning, I., How It Works: Strengthening Glass](fracture-resistant smartphone glass), where a fraction of the near-surface Na⁺ (ionic radius: 1.15 Å) in the sodium based glass is exchanged with K⁺ (ionic radius: 1.52 Å) [see Shannon, R. D., Revised Effective Ionic Radii and Systematic Studies of Interatomie Distances in Halides and Chaleogenides. Acta Cryst 1976, A32, 751-767]. By exchanging up to 20 μm deep in the subsurface region, ion exchange induced compressive stresses on the order of 1 GPa are attained [see Murayama, S., Ohara, S., Li, Q. & Akiba, S WO 2017/126607 A1. 2017; Terakado, N.; Sasaki, R.; Takahashi, Y.; Fujiwara, T.; Orihara, S.; Orihara, Y., A novel method for stress evaluation in chemically strengthened glass based on micro-Raman spectroscopy. Communications Physics 2020, 3 (1)], strongly inhibiting formation and growth of fractures).

### SUMMARY OF THE INVENTION

At Aspects of the present disclosure are directed to a method of suppressing crack growth in lithium-based solid-state electrolytes to inhibit lithium filament penetration.

According to one aspect, lithium ions in a lithium-based solid state electrolyte are substituted with ions having a larger ionic radius compared to lithium ions, such as potassium ions, silver ions, sodium ions, calcium ions, and the like and mixtures thereof. According to one aspect, the present disclosure is directed to a lithium-based solid-state electrolyte with lithium ions exchanged with ions having a larger ionic radius compared to lithium ions, such as potassium ions, silver ions, sodium ions, calcium ions and the like and mixture thereof. According to one aspect, lithium ions in a lithium-based solid-state electrolyte are substituted with potassium ions using an ion exchange method. According to one aspect, lithium ions in a lithium-based solid-state electrolyte are substituted with silver ions using an ion exchange method. According to one aspect, lithium ions in a lithium-based solid-state electrolyte are substituted with one or more of potassium ions, silver ions, sodium ions, calcium ions and the like using an ion exchange method. According to one aspect, the substitution of lithium ions with cationic ions having a larger ionic radius compared to lithium ions of the same or different type or a mixture thereof generates residual compressive stresses in the near surface region of the solid electrolyte. According to one aspect, lithium ions in a lithium-based solid-state electrolyte are substituted with monovalent cations having a larger ionic radius compared to lithium ions. According to one aspect, lithium ions in a lithium-based solid-state electrolyte are substituted with divalent cations having a larger ionic radius compared to lithium ions. Without wishing to be bound by scientific theory, such residual compressive stress generated by the ion exchange methods described herein is believed to inhibit filament growth in ASSBs [see Qi, Y.; Ban, C.; Harris, S. J., A New General Paradigm for Understanding and Preventing Li Metal Penetration through Solid Electrolytes. Joule 2020, 4 (12), 2599-2608]. Such residual compressive stress generated by the ion exchange methods described herein reduces the possibility of brittle failure during cell assembly or from mechanical abuse. According to one aspect, a method is provided to induce residual compressive stresses by means of a chemical modification of the solid electrolyte surface region to exchange lithium ions with ions having a larger ionic radius compared to lithium ions, such as potassium ions, silver ions, sodium ions, calcium ions and the like. According to one aspect, lithium ions are exchanged with ions having a larger ionic radius compared to lithium ions while allowing lithium ions to diffuse. According to one aspect, such ions may be monovalent cationic ions. According to one aspect, such ions may be divalent cationic ions. In superionic solid electrolytes, Li⁺ has a high diffusivity. Diffusion being a thermally activated, chemo-mechanically coupled phenomenon, depends on the concentration of Li⁺, temperature and stress [see Chang, S.; Moon, J.; Cho, M., Stress-diffusion coupled multiscale analysis of Si anode for Li-ion battery†. Journal of Mechanical Science and Technology 2015, 29 (11), 4807-4816; Verma, M. K. S.; Basu, S.; Hariharan, K. S.; Kolake, S. M.; Song, T.; Jeon, J., A Strain-Diffusion Coupled Electrochemical Model for Lithium-Ion Battery. Journal of The Electrochemical Society 2017, 164 (13), A3426-A3439; Cherubini, C.; Filippi, S.; Gizzi, A.; Ruiz-Baier, R., A note on stress-driven anisotropic diffusion and its role in active deformable media. J Theor Biol 2017, 430, 221-228; Youssef, G.; Fréour, S.; Jacquemin, F., Stress-dependent Moisture Diffusion in Composite Materials. Journal of Composite Materials 2009, 43 (15), 1621-1637]. This stress in turn depends on the concentration of K⁺. Accordingly, one aspect of the present disclosure is to exchange lithium ions with ions having a larger ionic radius compared to lithium ions and analyzing stress, concentration and temperature. Although higher compressive stresses are desirable to prevent filament growth, there exists a limit of the maximum concentration of exchanged ions to allow sufficient Li⁺ ion diffusivity. In one aspect, pressure dependent diffusivity [see Aziz, M. J., Thermodynamics of diffusion under pressure and stress: Relation to point defect mechanisms. Appl. Phys. Lett 1997, 70 (21), 2810-2812] is analyzed and a two-step fitting method is used to deconvolute the impact of cation concentration, stress and temperature on the diffusivity instead of using the traditional Arrhenius fitting.

According to one aspect, methods are provided to inhibit or limit filament growth of lithium within solid-state lithium metal anode batteries. According to one aspect, increasing the fracture toughness of the solid electrolytes is believed to inhibit filament penetration or growth into pre-existing or nascent cracks in the solid electrolyte. According to one aspect, introducing residual compressive stresses at the surface of the solid electrolyte increases fracture resistance. According to one aspect as summarized in FIG. 1, residual compressive stresses are induced by exchanging lithium ions (Li⁺) with larger isovalent ions, such as potassium ions (K⁺). It is to be understood that the present disclosure is not limited to potassium ions, but that other ions having a larger ionic radius than lithium ions, such as silver ions, sodium ions, calcium ions and the like are contemplated as producing improved electrical properties of the solid electrolytes. Such ions having a larger ionic radius than lithium ions include monovalent or divalent cationic ions. According to one aspect, lithium ions are exchanged with ions having a larger ionic radius than lithium ions in an amount to allow sufficient lithium ion diffusion for performance of the solid-state electrolyte in a solid-state battery. According to one aspect, lithium ions are exchanged with potassium ions in an amount to allow sufficient lithium ion diffusion for performance of the solid-state electrolyte in a solid-state battery. According to one aspect, lithium ions are exchanged with silver ions in an amount to allow sufficient lithium ion diffusion for performance of the solid-state electrolyte in a solid-state battery. According to one aspect, lithium ions are exchanged with sodium ions in an amount to allow sufficient lithium ion diffusion for performance of the solid-state electrolyte in a solid-state battery. According to one aspect, lithium ions are exchanged with calcium ions in an amount to allow sufficient lithium ion diffusion for performance of the solid-state electrolyte in a solid-state battery.

According to one aspect, the amount of lithium ions exchanged with cationic ions having a larger ionic radius may be determined by the amount of compressive stress desired and the desired amount of lithium conductivity. Based on the present disclosure, one of skill will be able to tune the amount of a cationic ion sought to be exchanged and included into the lithium-based solid electrolyte based on desired compressive stress and lithium conductivity.

According to one aspect, between 2% and 5% lithium ions are exchanged with cationic ions having a larger ionic radius than lithium ions. According to one aspect, between 3% and 4% lithium ions are exchanged with cationic ions having a larger ionic radius than lithium ions. According to one aspect, between 2% and 4% lithium ions are exchanged with cationic ions having a larger ionic radius than lithium ions. According to one aspect, between 3% and 5% lithium ions are exchanged with cationic ions having a larger ionic radius than lithium ions. According to one aspect, between 4% and 5% lithium ions are exchanged with cationic ions having a larger ionic radius than lithium ions. According to one aspect, between 2% and 5% lithium ions are exchanged with potassium ions. According to one aspect, between 3% and 4% lithium ions are exchanged with potassium ions. According to one embodiment 3.4% lithium ions are exchanged with potassium ions. Without wishing to be bound by scientific theory, it is generally believed that the percent of lithium ions exchanged is generally dependent on the kinetic mobility of ions in the solid electrolyte.

According to one aspect, the lithium ions are exchanged with potassium ions up to a depth twice of grain sizes in a Li₇La₃Zr₂O₁₂ solid-state electrolyte. Such an exchange induces a residual compressive stress of around 1.1 GPa (although higher compressive stresses may be obtainable), corresponding to an increase in fracture resistance by about 8 times compared to a solid electrolyte without the ion exchange, while lowering the diffusivity by a factor of 5 at room temperature compared to a solid electrolyte without the ion exchange. The reduction of lithium diffusivity is due to K⁺ induced stress and blockage of lithium ion pathways; however, such reduction is advantageously higher than some other common solid-state electrolytes.

### BRIEF DESCRIPTION OF DRAWINGS

The patent or application file contains at least one drawing executed in color. Copies of this patent or patent application publication with color drawing(s) will be provided by the Office upon request and payment of the necessary fee. The foregoing and other features and advantages of the present embodiments will be more fully understood from the following detailed description of illustrative embodiments taken in conjunction with the accompanying drawings in which:

FIG. 1 is a schematic depicting lithium ions exchanged with potassium ions in an amount to allow sufficient lithium ion diffusion for performance of the solid-state electrolyte in a solid-state battery.

FIG. 2 depicts the effect of the local coordination environment on the stability of IX configuration. FIG. 2(a) depicts the relative energy of the configurations referenced to the lowest energy configuration (O2). Open (unfilled) symbols represent the un-relaxed energies, while solid (filled) symbols represent the energies after relaxation. The circles correspond to K in an octahedral site, while the squares refer to the K in a tetrahedral site. The b-e letters in a) correspond to the configurations shown schematically in FIG. 2b-FIG. 2e, where the square and rectangular shapes represent connected tetrahedral and octahedral sites respectively. FIG. 2b: Highest energy configuration where the K substitutes a Li in the tetrahedral site, with four occupied octahedral Li neighbors. FIG. 2c: Lowest energy configuration where the K jumps out of the tetrahedral site to an unoccupied neighboring octahedral site upon relaxation. FIG. 2d: Relatively high energy configuration with K in an octahedral site and two neighboring tetrahedral neighbors. FIG. 2 e: The most stable configuration, where the K is in an octahedral site with one neighboring tetrahedral site occupied by Li and another one empty.

FIG. 3 depicts a map of the reaction conditions for ion exchange. FIG. 3a: Dependence of the K-substitutional free energy E_{f} (in eV) on the temperature (T) and partial pressure of oxygen (p_{O}_{₂}) on the potassium oxide precursor chosen. The solid lines are for KO₂, the dotted lines (- - -) are for K₂O₂, while the microdots ( . . . ) are for K₂O. Since IX with K₂O, does not produce any excess oxygen, the E_{f}^{K}^{₂}^{O} does not exhibit dependance on the p_{O}_{₂}. FIG. 3b: Equilibrium defect concentration C_{K}^{eq}(T, p_{O}_{₂}) when using the KO₂ precursor. Dotted horizontal lines represent the zones of conditions permitting ˜3-5% IX.

FIG. 4 is a comparison of the mean square displacement of K in IX-LLZO at 1200K showing a large amount of hopping at low concentration of ˜1.7% K in IX-LLZO and negligible hopping at higher concentration (>3.4% K) The solid lines represent MSD at constrained volume, while the dotted curves represent MSD at relaxed volume (σ=0). While pressure has mild effect on the diffusivity at C_{K} ˜1.7%, no major effect at higher concentration.

FIG. 5 depicts diffusivity of IX-LLZO and the modified Arrhenius fitting. FIG. 5a: Diffusivity of IX-LLZO at 1200K at varied simulation volume. Red circles highlight the iso-volume (13.003 Å lattice parameter case). FIG. 5 b: Modified Arrhenius fitting of the diffusivity of LLZO. FIG. 5c: Room temperature diffusivity of Li in IX-LLZO at thin film compression and zero compression. The inset shows a schematic of the blockage in Li diffusion network explaining the increase in the activation barrier. Red squares represent the tetrahedral, yellow rectangles represent the octahedral, and gray sites represents the occupied stable K octahedral site. The tetrahedral Li⁺ with the stars shows the blockage in the Li⁺ diffusion network.

FIG. 6 is a schematic of the shallow depth ion exchanged thin film LLZO. The vertical axis is scaled as the thickness of the electrolyte. Gray region represents the ion-exchange region with uniform C_{K}=3.4% and the yellow region represents the bulk of the solid-state electrolyte with C_{K}=0%. The solid ( ) blue curve represents the concentration profile C_{K}, The vertical dotted black line (scaled to the bottom axis represents the zero of stress) curves to the left represent compression, and right represents tension. The dotted dashed (- ⋅) red curve indicates the stress profile (scaled to the bottom x axis). The dashed green curve (- -) represents the D_{Li} (scaled to the top x axis) at the actual macroscopic thin film compressive stress and 300K in the solid-state electrolyte, showing a negligible drop in diffusivity across the sample.

FIG. 7 which is a comparison of DFT vs single point MD energy configurations for Li55K1LZO, with respect to the respective lowest energy structure (in eV).

FIG. 8 depicts fitting of the lattice constant with Pressure to yield the equilibrium lattice constant at the zero of pressure used for computing the chemical expansion coefficient.

FIG. 9 is a graph of potential versus time for a symmetric Coin Cell with Baseline Pellet (Polished, 400° C. 3 hours).

FIG. 10 is a graph of potential versus time for a Symmetric Quick-Assembly Split Coin Cell with Baseline Pellet (Polished, 400° C. 3 hours, 800° C. 10 hours, 400° C. 1 hour, repolished).

FIG. 11 is a graph of potential versus time for a Symmetric Coin Cell with Baseline Gold Covered Pellet (Polished, 400° C. 3 hours, 5 nm gold, 800° C. 15 hours, 175° C. 8 hours, repolished).

FIG. 12 is a graph of potential versus time for a magnified version of electrochemical data for ion-exchanged pellet tested in Symmetric Quick-Assembly Split Coin Cell (Polished, 400° C. 3 hours, 800° C. 10 hours with KCl powder, 400° C. 1 hour, repolished).

FIG. 13 is a graph of potential versus time for a Magnified version of electrochemical data for ion-exchanged pellet tested in Symmetric Quick-Assembly Split Coin Cell (Polished, 400° C. 3 hours, 800° C. 10 hours with KCl powder, 400° C. 1 hour, repolished).

FIG. 14 is an image of the cracked pellet evidencing Li deflecting from the surface of the ion-exchanged LLZTO and traveling laterally (side 1).

FIG. 15 is an image of the cracked pellet evidencing Li deflecting from the surface of the ion-exchanged LLZTO and traveling laterally (side 2).

FIG. 16 is an example of a CCD plot with only negative current being applied to ion-exchanged sample S2 with CCD of 1.4 mA/cm².

FIG. 17 is an example of a CCD plot with alternating negative and positive current being applied to half treated sample S14 with CCD of 1 mA/cm².

FIG. 18 is a graph of Sample B3 XRD sin² ϕ data for a pristine pellet with σ=−333.1 MPa, R2=0.9661, y=−0.00459x+1.733.

FIG. 19 is a graph of Sample S41 XRD sin² ϕ measurements made on silver side of pellet with σ=−989.3 MPa, R2=0.7264, y=−9.03e-13x+1.83e-10.

FIG. 20 is an image of Sample S41, curved after the ion-exchange process and with a silver layer on the bottom from AgNO₃.

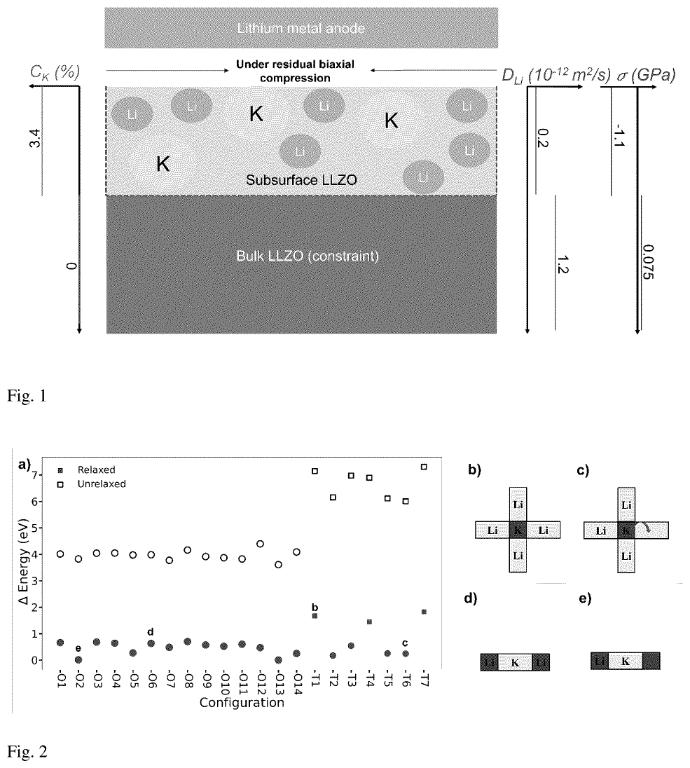

### DETAILED DESCRIPTION

The present disclosure is directed to the use of ion-exchange methods to exchange lithium ions with cationic ions having an ionic radius larger than lithium ions, such as potassium ions or silver ions, or sodium ions or calcium ions and the like in a lithium-based solid-state electrolyte. According to one aspect, a method is provided for the exchange of a small fraction of the near-surface Li⁺ (ionic radius: of 0.9 Å) in a solid-state electrolyte with K⁺. An exemplary solid-state electrolyte is Lithium Lanthanum Zirconium Oxide (LLZO) [see Venkataraman Thangadurai, H. K., and Werner J. F. Weppner, Novel Fast Lithium Ion Conduction in Garnet-Type Li₅La₃M₂O₁₂ (M=Nb, Ta). J. Am. Ceram. Soc 2003, 86, 437-40; Thangadurai, V.; Narayanan, S.; Pinzaru, D., Garnet-type solid-state fast Li ion conductors for Li batteries: critical review. Chem Soc Rev 2014, 43 (13), 4714-27] which has a high ionic conductivity 10⁻³ S/cm [see Jalem, R.; Yamamoto, Y.; Shiiba, H.; Nakayama, M.; Munakata, H.; Kasuga, T.; Kanamura, K., Concerted Migration Mechanism in the Li Ion Dynamics of Garnet-Type Li₇La₃Zr₂O₁₂. Chemistry of Materials 2013, 25 (3), 425-430; Klenk, M.; Lai, W., Local structure and dynamics of lithium garnet ionic conductors: tetragonal and cubic Li₇La₃Zr₂O7. Phys Chem Chem Phys 2015, 17 (14), 8758-68] and a low chemical reactivity. Although most of the common properties-mechanical response [see Yu, S.; Schmidt, R. D.; Garcia-Mendez, R.; Herbert, E.; Dudney, N. J.; Wolfenstine, J. B.; Sakamoto, J.; Siegel, D. J., Elastic Properties of the Solid Electrolyte Li₇La₃Zr₂O₁₂ (LLZO). Chemistry of Materials 2015, 28 (1), 197-206], activation barrier [see Pesci, F. M.; Bertei, A.; Brugge, R. H.; Emge, S. P.; Hekselman, A. K. O.; Marbella, L. E.; Grey, C. P.; Aguadero, A., Establishing Ultralow Activation Energies for Lithium Transport in Garnet Electrolytes. ACS Appl Mater Interfaces 2020, 12 (29), 32806-32816; Wang, Y.; Klenk, M.; Page, K.; Lai, W., Local Structure and Dynamics of Lithium Garnet Ionic Conductors: A Model Material Li5La3Ta2O12. Chemistry of Materials 2014, 26 (19), 5613-5624], Li⁺ transport mechanism [see Jalem, R.; Yamamoto, Y.; Shiiba, H.; Nakayama, M.; Munakata, H.; Kasuga, T.; Kanamura, K., Concerted Migration Mechanism in the Li Ion Dynamics of Garnet-Type Li₇La₃Zr₂O₁₂. Chemistry of Materials 2013, 25 (3), 425-430; Klenk, M.; Lai, W., Local structure and dynamics of lithium garnet ionic conductors: tetragonal and cubic Li₇La₃Zr₂O7. Phys Chem Chem Phys 2015, 17 (14), 8758-68], interfacial behavior [see Kim, K. H.; Iriyama, Y.; Yamamoto, K.; Kumazaki, S.; Asaka, T.; Tanabe, K.; Fisher, C. A. J.; Hirayama, T.; Murugan, R.; Ogumi, Z., Characterization of the interface between LiCoO₂ and Li₇La₃Zr₂O₁₂ in an all-solid-state rechargeable lithium battery. Journal of Power Sources 2011, 196 (2), 764-767; Delluva, A. A.; Dudoff, J.; Teeter, G.; Holewinski, A., Cathode Interface Compatibility of Amorphous LiMn₂O₄ (LMO) and Li₇La₃Zr₂O₁₂ (LLZO) Characterized with Thin-Film Solid-State Electrochemical Cells. ACS Appl Mater Interfaces 2020, 12 (22), 24992-24999; Kato, A.; Kowada, H.; Deguchi, M.; Hotehama, C.; Hayashi, A.; Tatsumisago, M., XPS and SEM analysis between Li/Li₃PS₄ interface with Au thin film for all-solid-state lithium batteries. Solid State Ionics 2018, 322, 1-4], and doping strategies [see Shin, D. O.; Oh, K.; Kim, K. M.; Park, K. Y.; Lee, B.; Lee, Y. G.; Kang, K., Synergistic multi-doping effects on the Li₇La₃Zr₂O₁₂ solid electrolyte for fast lithium ion conduction. Sci Rep 2015, 5, 18053; Karasulu, B.; Emge, S. P.; Groh, M. F.; Grey, C. P.; Morris, A. J., Al/Ga-Doped Li₇La₃Zr₂O₁₂ Garnets as Li-Ion Solid-State Battery Electrolytes: Atomistic Insights into Local Coordination Environments and Their Influence on (17)O, (27)Al, and (71)Ga NMR Spectra. J Am Chem Soc 2020, 142 (6), 3132-3148] are well established for LLZO, Li filament growth can inhibit performance of Lithium Lanthanum Zirconium Oxide (LLZO) as a solid-state electrolyte in a solid-state battery.

According to one aspect, the theoretical effect of exchanging different concentrations of Li⁺ in LLZO with K⁺ in the sub-surface region was analyzed. According to one aspect based on DFT calculations, potassium can take stable octahedral (96h) sites in the LLZO, contrary to lithium which slightly prefers the tetrahedral (24d) site. The energy cost of substituting Li⁺ with K⁺ in LLZO can be low enough to achieve an equilibrium K⁺ concentration of a few percentages with temperature and oxygen partial pressure dependent KO₂ as the precursor. Molecular dynamics (MD) simulation results show that potassium has reasonable mobility at a 1.7% concentration and is almost immobile at a 3.4% concentration. According to one aspect, potassium is exchanged at high temperatures (1200K) where the potassium are mobile at low concentration; and the process shuts-off in a self-limited fashion beyond a certain concentration. Once the desired exchange concentration is achieved in the subsurface region, the electrolyte is quenched to room temperature to immobilize the K⁺. The pressure calculated from MD was used as an input for a thin-film based continuum model to evaluate the surface residual compressive stress, which was found to be around 1.1 GPa for a 3.4% exchange of Li+ ions. Using MD simulations, it was found that this K⁺ concentration is likely to be an upper bound, as the diffusivity of lithium ions is reduced by a factor of 0.19, largely due to K⁺ blocking of the Li+ diffusion pathway. According to one aspect, the ion exchange depth ratio is 0.2-4% or from 2 to 40 μm for a 1 mm thick LLZO solid electrolyte with a grainsize of 1 to 20 μm. For a 20 am grain, the fracture strength increased significantly from 150 MPa to 1,086 MPa at this ion exchange level.

### Example I

### Modelling Ion-Exchange and the Coupled Stress-and-Diffusion Processes in Solid Electrolytes

Modelling ion-exchange and the coupled stress-and-diffusion processes in solid electrolytes requires connecting models at the atomistic, nano, and continuum scales. Firstly, Density Functional Theory (DFT) calculations were performed to identify the favorable sites for K⁺ in LLZO, followed by calculating the ion-exchange energies. To serve as a guide for experimental ion-exchange conditions at elevated temperatures, DFT-informed-thermodynamics calculations were performed to analyze different precursor materials, which can act as sources for K⁺, such as potassium metal and potassium oxides; and the ion-exchange conditions. Secondly, molecular dynamics (MD) calculations were used to understand the effect of ion-exchange on the diffusivity of Li⁺ and K⁺ in LLZO. Finally, the atomistic scale chemical strain induced by K⁺ was used as an input for a continuum scale thin film residual stress model to predict the macroscopic stress profile as a function of IX depth in the solid-state electrolyte. Based on the above methodology, a maximum residual compressive stress equal to about 1.1 GPa can be induced by exchanging 3.4% of Li⁺ over an exchange depth ratio (IX region/electrolyte thickness) of 2% near the sub-surface region (for example, 10 μm of the near surface region for a 1 mm thick electrolyte). The Li⁺ diffusivity in LLZO before ion-exchange (1.3×10⁻¹² m²/s) drops by less than an order of magnitude at 300K, due to K⁺ induced stress and mainly blocking of Li⁺ pathways.

### Example II

### DFT Calculations

DFT calculations were employed to identify stable sites or configurations for K⁺ exchange and for determining accurate substitutional energies in LLZO. Plane wave DFT was implemented in the Vienna Ab-initio Simulation Package (VASP) [see Hafner, J.; Kresse, G., The Vienna AB-Initio Simulation Program VASP: An Efficient and Versatile Tool for Studying the Structural, Dynamic, and Electronic Properties of Materials. In Properties of Complex Inorganic Solids, 1997; pp 69-82]. The core-valence electron interaction was modeled using the projected plane waves (PAW) method and the Generalized Gradient Approximation (GGA) by Perdew, Burke and Emzerhof (PBE) [see John P. Perdew, K. B., Matthias Ernzerhof, Generalized Gradient Approximation Made Simple. Physical Review Letters 1996, 77 (4), 3865-3868] was used for the electron exchange correlation functional. For electronic relaxation, the energy convergence criterion was 10⁻⁵ eV with a cutoff energy of 600 eV, and a Gaussian smearing of 0.1 eV was used. For ionic minimization, the force criterion per atom was less than 0.03 eV/A. For K-exchanged-LLZO simulation cells with 192 atoms, a 1×1×1 Monkhorst-Pack K-point grid was used.

The cubic la3d structure of LLZO was simulated as a cubic cell with 8(Li₇La₃Zr₂O₁₂) atoms with a starting lattice constant of 13.003 Å. Li atoms were assigned to partially-occupied 24d (54% occupancy) and 96h (45% occupancy) sites in the cubic LLZO following a set of distribution principles [see Tian, H.-K.; Liu, Z.; Ji, Y.; Chen, L.-Q.; Qi, Y., Interfacial Electronic Properties Dictate Li Dendrite Growth in Solid Electrolytes. Chemistry of Materials 2019, 31 (18), 7351-7359; Xu, M.; Park, M. S.; Lee, J. M.; Kim, T. Y.; Park, Y. S.; Ma, E., Mechanisms of Li+ transport in garnet-type cubic Li₃₊ₓLa₃M₂O₁₂ (M=Te, Nb, Zr). Physical Review B 2012, 85 (5), 052301; Michael P. O'Callaghan, A. S. P., Jeremy J. Titman, George Z. Chen, and; Cussen, E. J., Switching on Fast Lithium Ion Conductivity in Garnets: The Structure and Transport Properties of Li₃₊ₓNd₃Te₂—SbₓO₁₂. Chem. Mater 2008, 20, 2360-2369; Xie, H.; Alonso, J. A.; Li, Y.; Fernandez-Diaz, M. T.; Goodenough, J. B., Lithium Distribution in Aluminum-Free Cubic Li7La3Zr2O12. Chemistry of Materials 2011, 23 (16), 3587-3589; Cussen, E. J., The structure of lithium garnets: cation disorder and clustering in a new family of fast Li⁺ conductors. Chem Commun (Camb) 2006, (4), 412-3] to avoid electrostatically-unfavorable ionic configurations. Properties of other materials used in the calculations, including the cubic Im3m Li-metal and K-metal, cubic Fm3m Li₂O, K₂O, the Cmce K₂O₂ and 14/mmm KO₂ were taken from The Materials Project [see A. Jain, S. P. O., G. Hautier, W. Chen, W. D. Richards, S. Dacek, S. Cholia, D. Gunter, D. Skinner, G. Ceder, K. A. Persson, The Materials Project: A materials genome approach to accelerating materials innovation. APL Materials 2013, 1, 011002] along with their recommended DFT settings.

With the current simulation cell (Li₅₆La₂₄Zr₁₆O₉₆), when nᵢ number of Li⁺ are exchanged with K⁺ to obtain Li₅₆₋ₙKₙLa₂₄Zr₁₆O₉₆, the K-substitutional energy, E_{f}, is defined as:

$${E}_{f} = ( {E}_{ix} - {E}_{bulk} + {\sum }_{i} {n}_{i} Δ {μ}_{i} ) / {n}_{i} \qquad ( Eq 1 )$$

where Eᵢₓ and E_{bulk} refer to the DFT computed energy of the ion-exchanged and pristine LLZO simulation cells respectively, Δμᵢ and nᵢ refer to the chemical potential and the number of species exchanged respectively, thereby making E_{f} source dependent. nᵢ is positive (negative) if a species is generated (consumed) upon ion-exchange. In the limit of dilute exchange, E_{f} does not vary with the concentration of K⁺. When one Li⁺ is exchanged with one K⁺ to form Li₅₅K₁La₂₄Zr₁₆O₉₆, Eq 1 is reduced to

$${E}_{f} = {E}_{ix} - {E}_{bulk} + Δ {μ}_{Li} - Δ {μ}_{K} \qquad ( Eq 2 )$$

At 0K, with the same reference states (bonding with the same anionic species, ‘X’), e.g. Li metal vs. K metal, Li₂O vs. K₂O, the chemical potential difference of Li and K can be approximated by their energy differences, as Δμ_{Li}−Δμ_{K}=E_{LiX}^{DFT}−E_{KX}^{DFT}.

Thus, using pristine metallic precursors Li and K metal, E_{Li}^{DFT}=−1.90 eV and E_{K}^{DFT}=−1.05 eV, respectively, yields E_{f}=2.63 eV. A list of E_{f} values for different reference (K, K₂O, KF, KCl, K₂SO₄, KNO₃, K₃N, K₃PO₄, KPF₆, KClO₄) states with their respective values for E_{LiX}^{DFT}−E_{KX}^{DFT} are provided in Table 1.

TABLE 1

| Anion | E_{LiX}^{DFT} − E_{KX}^{DFT} (eV) | E_{f}(0K) (eV) |
|---|---|---|
| N/A (pure metallic) | −0.85 | 2.636 |
| Sulphate (SO₄⁾²⁻ | −2.29 | 1.196 |
| Oxide (O)²⁻ | −2.02 | 1.466 |
| Flouride (F)⁻ | −1.25 | 2.236 |
| Chloride (Cl)⁻ | −0.67 | 2.816 |
| Nitrate (NO₃)⁻ | −0.60 | 2.886 |
| Nitride (N)³⁻ | −1.93 | 1.556 |
| Phosphate (PO₄)³⁻ | −1.37 | 2.116 |
| Hexaflouride (PF₆)⁻ | −0.39 | 3.096 |
| Tetrafluoroborate (BF₄)⁻ | −0.49 | 2.996 |
| Chlorate (ClO₄) | −0.33 | 3.156 |

At finite temperatures T, the E_{f}(T) refers to the formation free energy, and Δμ_{Li}−Δμ_{K}=G_{LiX}−G_{KX}. To take advantage of the experimentally available Gibbs free energies, G^{exp}(T), for alkali metal oxides, we introduce the correction energy, ΔE_{correction}^{DFT-exp} [see Das, T.; Nicholas, J. D.; Qi, Y., Long-range charge transfer and oxygen vacancy interactions in strontium ferrite. Journal of Materials Chemistry A 2017, 5 (9), 4493-4506; Lee, Y.-L.; Kleis, J.; Rossmeisl, J.; Morgan, D., Ab initioenergetics of LaBO₃ (001) (B=Mn, Fe, Co, and Ni) for solid oxide fuel cell cathodes. Physical Review B 2009, 80 (22); Zhang, W.; Smith, J. R.; Wang, X. G., Thermodynamics from ab initio computations. Physical Review B 2004, 70 (2), 024103; Wang, L.; Maxisch, T.; Ceder, G., Oxidation energies of transition metal oxides within the GGA+Uframework. Physical Review B 2006, 73 (19), 195107] to connect it with DFT calculated energies, E^{DFT} via

$$G ( T ) = {E}^{DFT} + Δ {E}_{correction}^{DFT - exp} + {G}^{exp} ( T ) - Δ {H}_{f}^{0} ( T = 298 K ) \qquad ( Eq 3 )$$

where G^{exp}(T) and the experimental formation enthalpy ΔH_{f}⁰ (T=298K) are obtained from thermodynamic databases [see R. H. Lamoreaux, D. L. H., High Temperature Vaporization Behavior of Oxides I. Alkali Metal Binary Oxides. J. Phys. Chem. Ref. Data 1984, 13, 151-173; Dean, J. A., and Norbert Adolph Lange, Lange's Handbook of Chemistry. 7 ed.; New York: McGraw-Hill: 1999]. Following Wang, L.; Maxisch, T.; Ceder, G., Oxidation energies of transition metal oxides within the GGA+Uframework. Physical Review B 2006, 73 (19), 195107, ΔE_{correction}^{DFT-exp} was computed for each material species. Values are provided in Table 2 below.

TABLE 2

| Species | H_{f}⁰\|ₑₓₚₑᵣᵢₘₑₙₜ (eV) | H_{f}⁰\|_{DFT} (eV) | ΔE_{correction}^{DFT - exp} (eV) |
|---|---|---|---|
| Li₂O | −6.1960 | −5.5135 | −0.6825 |
| K₂O | −3.755 | −3.1952 | −0.5598 |
| K₂O₂ | −5.12 | −4.4084 | −0.7116 |
| KO₂ | −2.9485 | −2.7358 | −0.2127 |

When the reference states change for the case of superoxide (KO₂) and peroxide (K₂O₂) precursors to generate Li₂O, the reactions generate oxygen gas and hence E_{f}(T, p_{O}_{₂}) requires explicit correction for the chemical potential of oxygen (Δμ_{O}_{₂}), which is expressed as

$$Δ {μ}_{{0}_{2}} = {E}_{DFT}^{{O}_{2}} + Δ {E}_{correction}^{{O}_{2}} ( T , {p}_{{O}_{2}} ) + kT ln ( {p}_{{O}_{2}} ) \qquad ( Eq 4 )$$

where E_{DFT}^{O}^{₂} is the energy of an isolated oxygen gas molecule (−9.86 eV) in a box of 20×20×20 Å³ with a bond length of 1.23 Å as considered in Das, T.; Nicholas, J. D.; Qi, Y., Long-range charge transfer and oxygen vacancy interactions in strontium ferrite. Journal of Materials Chemistry A 2017, 5 (9), 4493-4506, ΔE_{correction}^{O}^{₂} (T, p_{O}_{₂}) is the correction energy at temperature (T) and oxygen partial pressure is p_{O}_{₂} [see Das, T.; Nicholas, J. D.; Qi, Y., Long-range charge transfer and oxygen vacancy interactions in strontium ferrite. Journal of Materials Chemistry A 2017, 5 (9), 4493-4506; Lee, Y.-L.; Kleis, J.; Rossmeisl, J.; Morgan, D., Ab initioenergetics of LaBO₃ (001) (B=Mn, Fe, Co, and Ni) for solid oxide fuel cell cathodes. Physical Review B 2009, 80 (22); Zhang, W.; Smith, J. R.; Wang, X. G., Thermodynamics from ab initio computations. Physical Review B 2004, 70 (2), 024103].

### Example III

### Molecular Dynamics Simulations

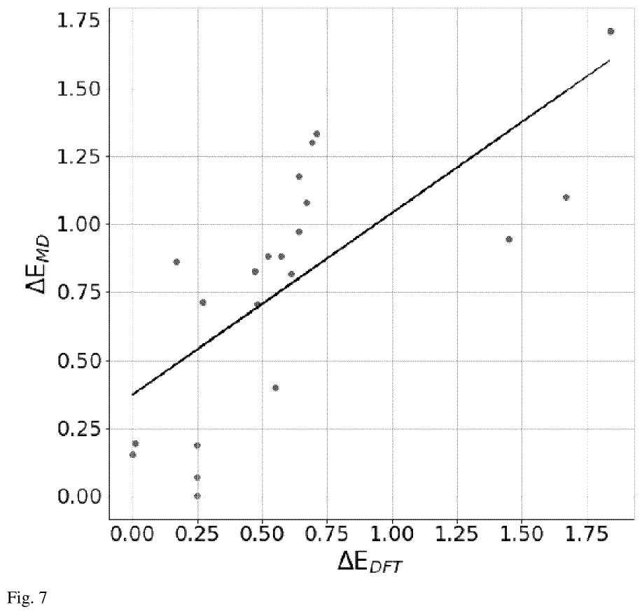

MD simulations were implemented to evaluate the diffusion coefficient as well as the chemical stress and strain induced by the exchange of Li‘ with K’ in LLZO. All MD simulations were carried using the General Utility Lattice Program (GULP) [see Gale, J. D., GULP: Capabilities and prospects. Z. Kristallogr. 2005, 220, 552-554] implemented in Materials Studio. The polarizable Bush force field, which includes the long-range Coulombic interaction, the short-range Buckingham interaction, and the polarizable core-shell model for Oxygen atoms, was used [see Qi, Y.; Ban, C.; Harris, S. J., A New General Paradigm for Understanding and Preventing Li Metal Penetration through Solid Electrolytes. Joule 2020, 4 (12), 2599-2608; Klenk, M.; Lai, W., Local structure and dynamics of lithium garnet ionic conductors: tetragonal and cubic Li₇La₃Zr₂O7. Phys Chem Chem Phys 2015, 17 (14), 8758-68; Yu, S.; Schmidt, R. D.; Garcia-Mendez, R.; Herbert, E.; Dudney, N. J.; Wolfenstine, J. B.; Sakamoto, J.; Siegel, D. J., Elastic Properties of the Solid Electrolyte Li₇La₃Zr₂O₁₂ (LLZO). Chemistry of Materials 2015, 28 (1), 197-206; Timothy S. Bush, J. D. G., Richard A. Catlow and Peter D. Battle, Self-consistent Interatomic Potentials for the Simulation of Binary and Ternary Oxides. J. Mater. Chem 1994, 4, 831-837]. Parameters for the force field are provided in Table 3 and Table 4 below, along with the comparison with DFT-computed relative site stability of K⁺ in IX-LLZO (See FIG. 7 which is a comparison of DFT vs single point MD energy configurations for Li55K1LZO, with respect to the respective lowest energy structure (in eV)).

TABLE 3
Buckingham parameters [⁷⁻⁹]

| Species | A (ev) | ρ (Å) | C (eV Å⁶) |
|---|---|---|---|
| Zr—O | 1385.02 | 0.3500 | 0 |
| La—O | 4579.23 | 0.3044 | 0 |
| Li—O | 632.102 | 0.2906 | 0 |
| *K—O | 3587.570 | 0.3000 | 0 |
| O—O | 22764.30 | 0.1490 | 27.63 |

TABLE 4
O core-shell parameters

| | |
|---|---|
| Y (e) | −2.76 |
| K (eVÅ-2) | 30.2 |
| m (a.u.) | 0.2 |

The simulation cells are similar to those in the DFT calculations. Three K⁺ concentrations, C_{K}, were considered, namely pristine LLZO or 0% K⁺, 1.7% K and about 3.4% K substitution for diffusion calculations (0, 1, or 2 substitutions per simulation cell). The Nose thermostat parameter was set to 0.1 ps and the equilibration time was set to 1 ps. The mean square displacement (MSD) for Li⁺ and K⁺, evaluated using the Forcite module in Materials Studio, were calculated based on NVT molecular dynamics (“NVT MD” where Number of atoms (N), Volume of box (V) and Temperature of system (T) is held constant) for 1.8 ns in the temperature range 1000K to 1500K for accelerated ion motions. Diffusivity was obtained from the linear relationship of MSD with time interval, which showed better linear behavior with starting times in the first 800 ps due to more accurate statistics [see Klenk, M.; Lai, W., Local structure and dynamics of lithium garnet ionic conductors: tetragonal and cubic Li₇La₃Zr₂O7. Phys Chem Chem Phys 2015, 17 (14), 8758-68; Wang, Y.; Klenk, M.; Page, K.; Lai, W., Local Structure and Dynamics of Lithium Garnet Ionic Conductors: A Model Material Li5La3Ta2O12. Chemistry of Materials 2014, 26 (19), 5613-5624].

### Example IV

### Modified Arrhenius Fitting

The MD-computed diffusivity, D, can be expressed as [see Aziz, M. J., Thermodynamics of diffusion under pressure and stress: Relation to point defect mechanisms. Appl. Phys. Lett 1997, 70 (21), 2810-2812]:

$$D = {D}_{0} {e}^{- {E}_{a} / kT} {e}^{- σ {V}^{*} / kT} \qquad ( Eq 5 )$$

where D₀, Eₐ and V* are the fitting parameters referred to as the diffusional pre-factor, the activation energy, and the activation volume respectively; and k, T refer to the Boltzmann constant and temperature, respectively.

A two-step fitting procedure was taken to decouple the stress and temperature effects. First, it was assumed that V* does not depend on T. Eq 5 therefore yields

$$\partial ln ( D ) / \partial σ = - {V}^{*} / kT \qquad ( Eq 6 )$$

V* was obtained by linearly fitting ln(D) vs σ at a given T (T=1200K in this work). σ is the average hydrostatic pressure in a series of NVT MD calculations at different cubic cell volumes, where the lattice constant was varied from 12.803 Å to 13.203 Å.

Next, Eq 5 was transformed to

$${De}^{+ σ {V}^{*} / kT} = {D}_{0} {e}^{- {E}_{a} / kT} \qquad ( Eq 7 )$$

A linear fitting of De^{+σV*/kT} vs 1/T leads to D₀ and Eₐ.

### Example V

### Chemical Expansion Coefficient

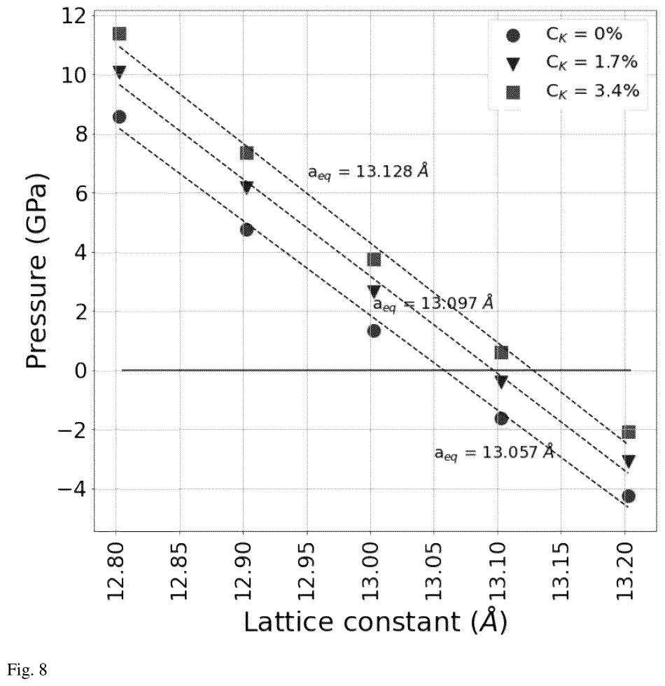

The chemical expansion coefficient (γ) was evaluated to quantify the macroscopic stress distribution in an LLZO film with a K-ion-exchanged surface layer. γ is expressed as

$$γ = \frac{{ϵ}_{c}}{{C}_{K}} = ( \frac{{a}_{eq} ( {C}_{K} )}{{a}_{0}} - 1 ) / {C}_{K} \qquad ( Eq 8 )$$

where ϵ_{c} refers to the chemical strain, and C_{K} is the concentration of Kin LLZO. The chemical strain is defined by the equilibrium lattice constant a_{eq} at a given C_{K}, and a₀ which is the equilibrium lattice constant of pristine LLZO (C_{K}=0). The equilibrium lattice constant at each C_{K} was obtained from a series of NVT MD. The lattice constant obtained from extrapolating the average pressure from these calculations to zero pressure is defined as the a_{eq}(C_{K}) (shown in FIG. 8 which depicts fitting of the lattice constant with Pressure to yield the equilibrium lattice

constant at the zero of pressure used for computing the chemical expansion coefficient.)

### Example VI

### Site Selectivity of Kin IX-LLZO

According to one aspect, the ion-exchange (IX) of K⁺ with Li⁺ was specifically considered because of the isovalency between Li⁺ and K⁺ and the relatively high energy penalty to remove and substitute La³⁺/Zr⁴⁺ with K⁺. The pristine LLZO simulation cell has 56 Li⁺ atoms occupying both the 24d tetrahedral sites (occupancy 54%) and 96h (occupancy 45%) octahedral sites. The Li⁺ filling rules mainly avoid short distances between Li⁺ ions to minimize the electrostatic repulsion interactions among them. There is no strong preference for Li⁺ to occupy a tetrahedral or octahedral site in cubic LLZO, although the geometrically smaller tetrahedral sites are slightly more favorable (by ˜0.2 eV [see Xu, M.; Park, M. S.; Lee, J. M.; Kim, T. Y.; Park, Y. S.; Ma, E., Mechanisms of Li+ transport in garnet-type cubic Li₃₊ₓLa₃M₂O₁₂ (M=Te, Nb, Zr). Physical Review B 2012, 85 (5), 052301; He, X.; Zhu, Y.; Mo, Y., Origin of fast ion diffusion in super-ionic conductors. Nat Commun 2017, 8, 15893], especially at low temperature, which leads to the tetragonal phase [see Allen, J. L.; Wolfenstine, J.; Rangasamy, E.; Sakamoto, J., Effect of substitution (Ta, Al, Ga) on the conductivity of Li₇La₃Zr₂O₁₂. Journal of Power Sources 2012, 206, 315-319; Larraz, G.; Orera, A.; Sanjuan, M. L., Cubic phases of garnet-type Li₇La₃Zr₂O₁₂: the role of hydration. Journal of Materials Chemistry A 2013, 1 (37). 11419-11428; Thompson, T.; Wolfenstine, J.; Allen, J. L.; Johannes, M.; Huq, A.; David, I. N.; Sakamoto, J., Tetragonal vs. cubic phase stability in Al-free Ta doped Li₇La₃Zr₂O₁₂ (LLZO). J. Mater. Chem. A 2014, 2 (33), 13431-13436]. However, this is not the case for K⁺ substitution. After randomly sampling 21 K⁺ exchanged configurations, a strong octahedral site preference for K⁺ appeared.

For a single exchange, the energy variation among the configurations, the coordination environments, and the local Li⁺ distribution around the exchanged site are shown in FIG. 2, where the tetrahedral exchange configurations (T) are shown as squares and the octahedral configurations (O) as circles. The energy is referenced to the fully relaxed lowest energy configuration. The unrelaxed cases are shown as open (or unfilled) figures while the fully relaxed structures are shown as closed (or filled) figures. It is evident that pre-relaxation, the tetrahedral sites are energetically unfavorable with respect to the octahedral sites. It is also observed that upon relaxation, the low energy configurations are octahedral, regardless of the initial configuration. Post relaxation, the difference between the stable octahedral and unstable tetrahedral configurations is large (˜1.6 eV) which indicates a strong preference for the K⁺ to inhabit the octahedral sites and not the tetrahedral sites. This implies that in case there is an empty octahedral (shown in chrome color in FIG. 2c) site available next to the K⁺ occupied tetrahedral site (shown in red in FIG. 2c), the K⁺ can jump to that site. The K⁺ only remains in a tetrahedral site (similar to case shown in FIG. 2b) when there is no empty neighboring octahedral site available. In this case, the energy is much higher for K⁺ on the tetrahedral sites. Among the octahedral configurations (such as in FIG. 2e and FIG. 2d), the more stable configuration in FIG. 2e has only one lithium neighbor in the tetrahedral site, experiencing less electrostatic repulsion among K⁺ and Li⁺ ions, compared to that with two neighboring Li⁺ neighbors FIG. 2d.

The different site preferences of Li⁺ and K⁺ in LLZO are mainly due to the large mismatch between the Li⁺ and K⁺ ionic radii (0.90 Å for Li⁺ and 1.52 Å for K⁺ [see Shannon, R. D., Revised Effective Ionic Radii and Systematic Studies of Interatomie Distances in Halides and Chaleogenides. Acta Cryst 1976, A32, 751-767]). The spatially larger octahedral site is strongly preferred by the larger K⁺, whereas the smaller tetrahedral site is mildly preferred by Li⁺. This is corroborated by comparing the equilibrium K—O bond length in K₂O (2.81 Å), and Li—O bond length in Li₂O (2.02 Å) [see A. Jain, S. P. O., G. Hautier, W. Chen, W. D. Richards, S. Dacek, S. Cholia, D. Gunter, D. Skinner, G. Ceder, K. A. Persson, The Materials Project: A materials genome approach to accelerating materials innovation. APL Materials 2013, 1, 011002]. In the lowest energy ion exchanged structure, the average K—O distance in an octahedral cage is 2.46 Å, which is short compared to the K—O distance in K₂O. On the other hand, the average Li—O bond distance in a tetrahedral cage is 1.94 Å, (thus roughly equal to the Li—O bond in Li₂O) and in an octahedral cage is 2.27 Å (thus proving about 12% bigger). This is crucial since for their long-range diffusion, the respective ions have to hop through both tetrahedral and octahedral sites since they are interconnected like city roads (octahedral sites) and crossings (tetrahedral sites). Blockage on any one can cause disruption in the passage of ions and therefore, the correlated hopping and long-range diffusion of both Li⁺ and K⁺ ions need to be simulated via dynamic simulations over a long-time span (as shown in Example VII below).

### Example VII

### Defect Energy Cost of K⁺-Exchange

Based on the most stable configuration from the previous section for K-exchanged LLZO, E_{f} was computed considering a variety of K⁺ precursors (as listed in Table 1), E_{f} (0K) reduces from 2.63 eV to 1.46 eV, as the source of K⁺ changes from metal to K₂O. This is because in the case of the K metal precursor, the product formed is Li metal. However, in the case of K₂O precursor, the product formed is Li₂O, which is more stable than K₂O. To achieve 5% equilibrium K⁺ concentration at 1200K, E_{f} should be ˜0.3 eV, as

$${C}_{k}^{eq} = {e}^{- ( \frac{{E}_{f}}{kT} )} .$$

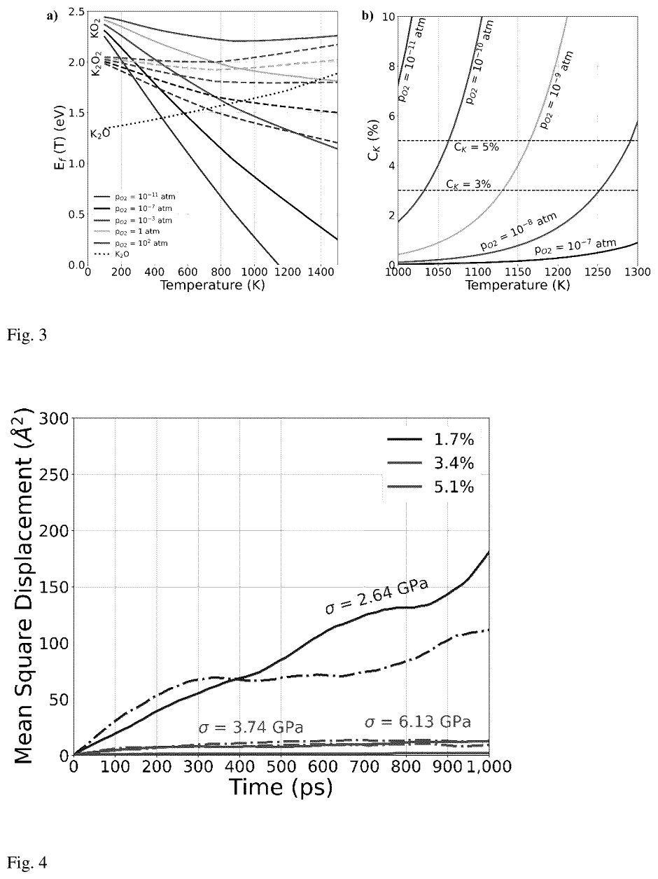

Some other commonly existing precursors all show high E_{f} (0K), however the oxide precursor is emphasized for two reasons. First, the energy difference, E_{LiX}^{DFT}−E_{KX}^{DFT}, is one of the highest amongst the precursors screened, leading to low E_{f} (0K). Second, some oxides of Potassium (K₂O₂, KO₂) show relative (meta) stability depending on the partial pressure of oxygen and temperature, while oxides of lithium do not. Thus, by tuning the temperature, and partial pressure of oxygen, the ion exchange process can be driven forward as evident in FIG. 3a.

The dependence of E_{f}(T, p_{O}_{₂}) on the oxygen partial pressure varies with the oxide precursor chosen as shown in FIG. 3a. Ion exchange with K₂O precursor (dotted gray line) does not release any O₂ (Eq SI.b), while K₂O₂ releases ¼ O₂ (Eq SI.c) and KO₂ releases ¾ O₂ (Eq SI.d) (each colored line represents a particular p_{O}_{₂} in the legend). Thus E_{f} for K₂O is independent of p_{O}_{₂} (Eq SI.3), for K₂O₂ it is mildly sensitive (Eq SI.4) and highly sensitive for KO₂ as evident in (Eq SI.5).

$${Li}_{56} {La}_{3} {Zr}_{2} {O}_{12} + ( \frac{1}{2} ) {K}_{2} O ↔ {Li}_{55} {K}_{1} {La}_{3} {Zr}_{2} {O}_{12} + ( \frac{1}{2} ) {Li}_{2} O \qquad ( Eq SI . b )$$

$$( Eq SI \text{.3} )$$

$${E}_{f} ( T ) = {E}_{ix} - {E}_{bulk} + ( \frac{1}{2} ) [ {E}_{DFT}^{{Li}_{2} O} + Δ \text{?} + {G}^{{Li}_{2} O} ( T ) - Δ \text{?} ( T = 298 K ) ] - ( \frac{1}{2} ) [ {E}_{DFT}^{{K}_{2} O} + \text{?} + {G}^{{K}_{2} O} ( T ) - Δ \text{?} ( T = 298 K ) ]$$

$$\text{?} \text{indicates text missing or illegible when filed}$$

$${Li}_{56} {La}_{3} {Zr}_{2} {O}_{12} + ( \frac{1}{2} ) {K}_{2} {O}_{2} ↔ {Li}_{55} {K}_{1} {La}_{3} {Zr}_{2} {O}_{12} + ( \frac{1}{2} ) {Li}_{2} O + ( \frac{1}{4} ) {O}_{2} \qquad ( Eq SI . c )$$

$$( Eq SI \text{.4} )$$

$${E}_{f} ( T , {p}_{{O}_{2}} ) = {E}_{ix} - {E}_{bulk} + ( \frac{1}{2} ) [ {E}_{DFT}^{{Li}_{2} O} + Δ \text{?} + {G}^{{Li}_{2} O} ( T ) - Δ \text{?} ( T = 298 K ) ] + ( \frac{1}{4} ) [ {E}_{DFT}^{{O}_{2}} + Δ {E}_{correction}^{{O}_{2}} + ( T , {p}_{{O}_{2}} ) + kT ln ( {p}_{{O}_{2}} ) ] - ( \frac{1}{2} ) [ {E}_{DFT}^{{K}_{2} {O}_{2}} + \text{?} + {G}^{{K}_{2} {O}_{2}} ( T ) - Δ \text{?} ( T = 298 K ) ]$$

$$\text{?} \text{indicates text missing or illegible when filed}$$

$${Li}_{56} {La}_{3} {Zr}_{2} {O}_{12} + {KO}_{2} ↔ {Li}_{55} {K}_{1} {La}_{3} {Zr}_{2} {O}_{12} + ( \frac{1}{2} ) {Li}_{2} O + ( \frac{3}{4} ) {O}_{2} \qquad ( Eq SI . d )$$

$$( Eq SI \text{.5} )$$

$${E}_{f} ( T , {p}_{{O}_{2}} ) = {E}_{ix} - {E}_{bulk} + ( \frac{1}{2} ) [ \text{?} + Δ \text{?} + {G}^{{Li}_{2} O} ( T ) - Δ \text{?} ( T = 298 K ) ] + ( \frac{3}{4} ) [ {E}_{DFT}^{{O}_{2}} + Δ {E}_{correction}^{{O}_{2}} + ( T , {p}_{{O}_{2}} ) + kT ln ( {p}_{{O}_{2}} ) ] - [ \text{} {E}_{DFT}^{{KO}_{2}} + \text{?} + {G}^{{KO}_{2}} ( T ) - Δ \text{?} ( T = 298 K ) ]$$

$$\text{?} \text{indicates text missing or illegible when filed}$$

The E_{f} (T) for the K₂O increases with temperature and is too high for ion exchange. For oxygen pressure sensitive KO₂, E_{f} (T, p_{O}_{₂}) is 2.27 eV at room temperature and 1 atm oxygen partial pressure and drops to 0.25 eV at 1200K and 10⁻⁹ atm, leading to Cₖ^{eq}=9%. Furthermore, at 1100K, under 10⁻¹¹ atm, the E_{f} can drop to ˜0 eV. (For reference an oxygen partial pressure up to 10⁻¹¹ atm (8×10⁻⁹ Torr) is readily achievable in vapor deposition chambers). Thus, K₂O precursor can achieve high tunability of ion exchange energy and K equilibrium concentration, as shown in FIG. 3b. For about 3.4% exchange at 1200K, the corresponding E_{f} (T=1200, p_{O}_{₂}=3.3×10⁻⁹ atm)=0.35 eV. FIG. 3b can be used as a map to determine the C_{K} for a given T, p_{O}_{₂} or vice versa.

The model of LLZO is pristine, with no defects. In laboratory samples however, defects like oxygen vacancies have been detected [see Kubicek, M.; Wachter-Welzl, A.; Rettenwander, D.; Wagner, R.; Berendts, S.; Uecker, R.; Amthauer, G.; Hutter, H.; Fleig, J., Oxygen Vacancies in Fast Lithium-Ion Conducting Garnets. Chemistry of Materials 2017, 29 (17), 7189-7196]. Existence of oxygen vacancies can lower the E_{f} to more commercially viable values at moderate temperatures and 1 atm. K⁺ was considered as an ion exchange source. However, the present disclosure contemplates other ions. According to one aspect, ion exchange of lanthanum, zirconium, and oxygen for lithium is contemplated and many other common sources (Na, Ag, etc) to exchange with Li may be used with different performance tradeoffs (lower E_{f}, lower σ_{c}, etc.).

### Example VIII

### Diffusion of Potassium in Ion Exchanged-LLZO

Ion exchange (IX) is thermodynamically feasible at elevated temperatures, and low oxygen partial pressures for KO₂. However, kinetics also need to be considered. Ideally, K⁺ is to be mobile at high temperatures, to build the necessary concentration profile during ion-exchange, and immobile during battery operation near room temperature.

To validate this requirement, NVT MD simulations were carried out and the mean square displacement (MSD) (shown in FIG. 4) of potassium was evaluated at 1200K, at three different concentrations of K⁺; viz, ˜1.7% (blue), ˜3.4% (green) and 5.1% (red). The temperature chosen was 1200K for thermodynamic and kinetic reasons, and it is below typical LLZO sintering temperatures (˜1500K) [see Barai, P.; Fister, T.; Liang, Y.; Libera, J.; Wolfman, M.; Wang, X.; Garcia, J.; Iddir, H.; Srinivasan, V., Investigating the Calcination and Sintering of Li7La3Zr2O12 (LLZO) Solid Electrolytes Using Operando Synchrotron X-ray Characterization and Mesoscale Modeling. Chemistry of Materials 2021, 33 (12), 4337-4352; Xue, W.; Yang, Y.; Yang, Q.; Liu, Y.; Wang, L.; Chen, C.; Cheng, R., The effect of sintering process on lithium ionic conductivity of Li6.4Al0.2La3Zr2O12 garnet produced by solid-state synthesis. RSC Adv 2018, 8 (24), 13083-13088]. For the MD simulations, two extreme cases were considered as shown in FIG. 4. The first case is where the simulation cell dimensions are held constant at a lattice constant a₀=13.003 Å, mimicking the highest local stress that can be generated if no relaxation occurs (shown in solid lines). The corresponding local hydrostatic pressures are 2.64 GPa, 3.74 GPa and 6.13 GPa respectively. At the other extreme, the simulation cell volumetrically relaxes to a_{eq}(C_{K}) (shown in dotted lines)

It is observed that K⁺ has reasonably high diffusivity when K⁺ concentration is C_{K}˜1.7% (solid lines). MD simulations starting from the low energy K⁺ configurations gave similar results shown in FIG. 4 and a D_{K}=2.1×10⁻¹⁴+0.8×10⁻¹⁴ m²/s at zero stress. The local stress has a mild effect on K⁺ diffusivity at low concentrations, as can be seen from the initial slope of the curve. However, as the concentration of K⁺ increases, the MSD decreases dramatically, irrespective of lattice stress. At about C_{K}-3.4% (green line), the MSD is reduced by a factor of about 7, while at higher concentrations, the MSD is nearly zero. The reduced diffusivity of K⁺ at higher concentration (>3.4%) originates from the larger local distortions of the K—O octahedral cage to accommodate the additional strain induced by other nearby K⁺. A similar phenomenon has been observed in other systems, where local distortion, caused by increasing dopant concentration, subsequently increases the migration barrier and reduces the ionic conductivity. [See Ding, J.; Balachandran, J.; Sang, X.; Guo, W.; Anchell, J. S.; Veith, G. M.; Bridges, C. A.; Cheng, Y.; Rouleau, C. M.; Poplawsky, J. D.; Bassiri-Gharb, N.; Unocic, R. R.; Ganesh, P., The Influence of Local Distortions on Proton Mobility in Acceptor Doped Perovskites. Chemistry of Materials 2018, 30 (15), 4919-4925]. In other words, at T˜1200K, the ion exchange process will be thermodynamically favorable and kinetically possible with sufficient diffusivity, when K⁺ concentration is low. As K⁺ concentration increases the ion exchange process shuts off in a self-limiting manner since beyond a certain threshold concentration of ˜3.4%, the MSD (and hence diffusivity) of K⁺ saturates (indicating, no possible hopping due to large local distortion). Once this step is achieved the IX-LLZO can be quenched to room temperature, thus virtually freezing the K⁺ in the sub-surface region.

### Example IX

### Diffusion of Lithium in IX-LLZO

Li⁺ diffusivity is evaluated at reasonably high temperatures (1000K-1500K) and using the modified Arrhenius fitting approach to extrapolate the diffusivity to room temperature. This is carried out for three concentrations C_{K}=0%, 1.7% and 3.4%. The choice of these concentrations is constrained by kinetic limitations because even at 1200K and 3.4% concentration, the K⁺ ions are only modestly mobile and do not exhibit significant hopping between sites. Thus 3.4% was chosen to be the highest concentration of exchange.

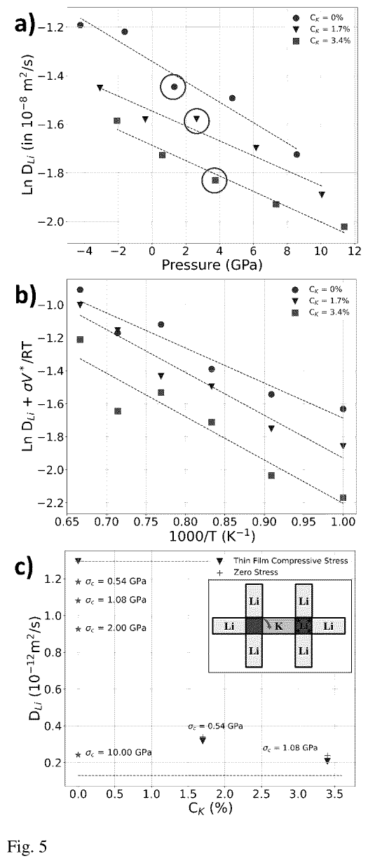

The two step diffusivity fitting for the three concentrations is shown in FIG. 5a and FIG. 5b. The activation volume, V*, captures the pressure dependence of diffusivity, and it is not very sensitive to C_{K}. For the ion exchange cases, V* is close to each other about 3.10×10⁻⁷ m³, while for the pristine case it is around 4.2×10⁻⁷ m³. The modified Arrhenius fitting in FIG. 5b shows different slopes, indicating that the activation barrier for the Li⁺ diffusivity changes after ion exchange. In the pristine case, the Eₐ is 0.18 eV, while for the ion exchange cases, the Eₐ increases to 0.22 eV. These match closely with a recent experimental study that found the activation barrier for grain transport is around 0.14 eV [see Pesci, F. M.; Bertei, A.; Brugge, R. H.; Emge, S. P.; Hekselman, A. K. O.; Marbella, L. E.; Grey, C. P.; Aguadero, A., Establishing Ultralow Activation Energies for Lithium Transport in Garnet Electrolytes. ACS Appl Mater Interfaces 2020, 12 (29), 32806-32816].

The fitting parameters listed in Table 5 below can be used to evaluate the lithium diffusivity at any temperature and pressure following Eq. 5. The extrapolated lithium diffusivities room temperature (T=300K) and zero stress (σ=0 Pa) values for the three concentrations are shown in FIG. 5c. The dotted black lines represent one order of magnitude drop from the pristine 0% case. Comparing the diffusivity at 0% and C_{K}=3.4%, shows a drop of less than one order of magnitude (20% of its original value) suggesting that the drop in diffusivity from ion exchange of Li⁺ diffusivity is still acceptable, as it is still as high or higher than many other common solid electrolytes [see Zhang, Z.; Shao, Y.; Lotsch, B.; Hu, Y.-S.; Li, H.; Janek, J.; Nazar, L. F.; Nan, C.-W.; Maier, J.; Armand, M.; Chen, L., New horizons for inorganic solid state ion conductors. Energy & Environmental Science 2018, 11 (8), 1945-1976; Bachman, J. C.; Muy, S.; Grimaud, A.; Chang, H. H.; Pour, N.; Lux, S. F.; Paschos, O.; Maglia, F.; Lupart, S.; Lamp, P.; Giordano, L.; Shao-Horn, Y., Inorganic Solid-State Electrolytes for Lithium Batteries: Mechanisms and Properties Governing Ion Conduction. Chem Rev 2016, 116 (1), 140-62]. Table 5 is a list of the fitting parameters for the three cases of ion exchange (0%, 1.7% and 3.4% exchanged LLZO). D₀, Eₐ and V* are the diffusional pre-factor, activation energy, and activation volume in Eq 5.

TABLE 5

| Concentration of K | D₀ (10⁻⁹ m²/s) | Eₐ (eV) | V* (10⁻⁷ m³) |
|---|---|---|---|
| 0% | 1.56 | 0.18 | 4.19 |
| 1.7% | 1.95 | 0.22 | 3.06 |
| 3.4% | 1.53 | 0.22 | 3.15 |

To confirm that the drop in diffusivity is primarily due to K⁺ concentration and not pressure, the zero-stress diffusivity is compared to the diffusivity at a pressure corresponding to the macroscopic maximum residual compressive stress in an ion exchanged thin film (0.53 GPa for 1.7% exchanged and 1.1 GPa for 3.4% exchange) in FIG. 5c. It can be seen that the incorporation of thin film pressure does not reduce the diffusivity significantly. To verify this, the diffusivity for the pristine LLZO (C_{K}=0%) was calculated from the fitted parameters at multiple hydrostatic compressive states; viz, 0.54 GPa, 1.08 GPa, 2 GPa and 10 GPa. At stresses as high as 10 GPa, the diffusivity loss of lithium is still less than one order of magnitude, thus showing that loss in diffusion of lithium in LLZO is primarily due to rise in the Eₐ after K⁺ exchange.

The increase in the Eₐ is understood by reflecting on the underlying lithium diffusion mechanism. In LLZO, lithium diffusion occurs by hopping through an interconnected network of 24d and 96h (asymmetric 48g site) sites as shown in the inset FIG. 5c where each red block represents a 24d site and each chrome block represents a unit of connected 96h₁-48g-96h₂ sites. It is to be noted that each symmetric 48g octahedron has 2 asymmetric 96h sites (within the same octahedron). Since only one of the two 96h sites can ever be filled by one cation, we use 48g to refer to the 96h₁-48g-96h₂ site complex within the same octahedron. For a lithium to hop from one 24d site to another 24d site, requires passing through a 48g site, where each 24d site is connected to 4 unique 48g sites (FIG. 2b), and each 48g site is in turn, connected to two unique 24d sites. (FIG. 2d). In the pristine case (C_{K}=0), the activation barrier between all sites is nearly equal, and hence all networks are possible for diffusion. In the C_{K}=1.7% case, as discussed earlier, potassium shows a strong preference to reside in the octahedral site. Thus, the potassium not only blocks lithium from hopping via the octahedral sites it occupies, it also chokes one of the nearest tetrahedral sites (as shown schematically in the inset of FIG. 5c with the stars). The occupancy of the tetrahedral sites is 13/24 about 54% while the occupancy of the 48g octahedral sites is 43/48 about 89.6% (or 45% of the 96h sites). Hence, hopping through the tetrahedral site is rate limiting. Thus, blocking of possible diffusion networks increases the effective Eₐ and hence can be a major reason for lithium diffusivity loss upon K⁺ exchange.

### Example X

### Macroscopic Residual Compressive Stress

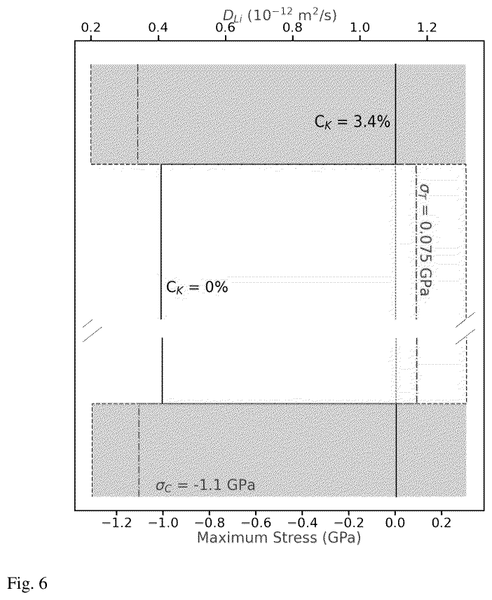

To evaluate the macroscopic stress induced by ion-exchange, shallow layers are assumed to be created on both surfaces. This allows C_{K} to be treated as uniform in the surface layer and zero in the bulk of the LLZO (as illustrated in FIG. 6). A more accurate concentration profile can be obtained by solving the diffusion equation, however, this solution may be complicated (i.e., not analytical) since D_{K} is a function of C_{K}. Thus, the use of a uniform value is sufficient for the approximate description presented here. This also makes it possible to simplify the residual stress and toughness enhancement with constant values.

In the surface layer, the residual stress, σ_{R}, is compressive, while in the bulk of the LLZO, the residual stress is tensile, σ_{T}. Since the ion exchange is assumed to be shallow, |σ_{C}|>>σ_{T} and t>>2λ, where λ is the approximate thickness of the ion exchange layer, t is the thickness of the LLZO·σ_{c} is the surface stress which is calculated as,

$$\vert {σ}_{C} \vert = \frac{γ \cdot E \cdot {c}_{K}}{( 1 - v )} \qquad ( Eq 9 )$$

where E is the Young's modulus, ν is the Poisson's ratio, and γ is chemical expansion coefficient defined in Eq 8.

The σ_{R} can be expressed as a function of the distance from the surface of the electrolyte to the bulk (x)

$${σ}_{R} ( x ) = \{ \begin{matrix}- {σ}_{c} , & x < λ \\ {σ}_{T} , & x > λ\end{matrix} . \qquad ( Eq 10 )$$

The tensile stress is related to the averaged K concentration through the total thickness of the LLZO film, t as

$${σ}_{T} = - {σ}_{C} \cdot \frac{2 λ}{( t - 2 λ )} \qquad ( Eq 11 )$$

In the case of LLZO, Porz et al evaluated E to be around 150 GPa [see Porz, L.; Swamy, T.; Sheldon, B. W.; Rettenwander, D.; Frömling, T.; Thaman, H. L.; Berendts, S.; Uecker, R.; Carter, W. C.; Chiang, Y. M., Mechanism of Lithium Metal Penetration through Inorganic Solid Electrolytes. Advanced Energy Materials 2017, 7 (20), 1701003] and Su et al estimated ν as 0.257 [see Yu, S.; Schmidt, R. D.; Garcia-Mendez, R.; Herbert, E.; Dudney, N. J.; Wolfenstine, J. B.; Sakamoto, J.; Siegel, D. J., Elastic Properties of the Solid Electrolyte Li₇La₃Zr₂O₁₂ (LLZO). Chemistry of Materials 2015, 28 (1), 197-206]. Since K⁺ and Li⁺ cations have different site preferences, the linear Vegard's strain is not appropriate to predict γ of K⁺ doped LLZO, [see Vegard, L., Die Konstitution der Mischkristalle und die Raumfullung der Atome. Zeitschrift für Physik 1921, 5 (1), 17-26; Zhang, K.; Wang, J.; Huang, Y.; Chen, L.-Q.; Ganesh, P.; Cao, Y., High-throughput phase-field simulations and machine learning of resistive switching in resistive random-access memory. npj Computational Materials 2020, 6 (1), 198] therefore γ was obtained based on MD simulations. The plot of MD computed pressure against the simulation cell lattice parameters at different C_{K} yields a_{eq}(C_{K})=13.059+0.2814C_{K} leading to γ=0.2814. Therefore, σ_{C} was estimated to be 0.54 GPa and 1.1 GPa for C_{K}=1.7% and C_{K}=3.4%, respectively. The Li⁺ diffusivity under these C_{K} and compressive stresses were evaluated based on the parameters shown in Table 5 and shown in FIG. 5c. The optimal value for C_{K} should maximize the residual compressive stress to inhibit crack propagation, while still providing sufficient current density. Therefore C_{K}=3.4% is recommended as the maximum concentration, beyond which the Li⁺ ion conductivity decreases by almost an additional order of magnitude.

To evaluate the efficacy of the proposed ion exchange layer, consider a pre-existing straight edge crack of length a. To prevent filament growth, the full benefit of the compressive stress requires a layer thickness, λ, that is larger than the critical flaw size, a_{C} (i.e., the largest surface flaw). For sintered LLZO (before ion exchange), this can be estimated from measured values of the tensile fracture strength, σ_{f}⁰˜150 MPa [see Huang, X.; Lu, Y.; Song, Z.; Xiu, T.; Badding, M. E.; Wen, Z., Preparation of dense Ta-LLZO/MgO composite Li-ion solid electrolyte: Sintering, microstructure, performance and the role of MgO. Journal of Energy Chemistry 2019, 39, 8-16], and the fracture toughness, K_{IC}⁰˜1 MPa·m^{(1/2)} [see Yu, S.; Schmidt, R. D.; Garcia-Mendez, R.; Herbert, E.; Dudney, N. J.; Wolfenstine, J. B.; Sakamoto, J.; Siegel, D. J., Elastic Properties of the Solid Electrolyte Li₇La₃Zr₂O₁₂ (LLZO). Chemistry of Materials 2015, 28 (1), 197-206; Huang, X.; Lu, Y.; Song, Z.; Xiu, T.; Badding, M. E.; Wen, Z., Preparation of dense Ta-LLZO/MgO composite Li-ion solid electrolyte: Sintering, microstructure, performance and the role of MgO. Journal of Energy Chemistry 2019, 39, 8-16; Wolfenstine, J.; Allen, J. L.; Sakamoto, J.; Siegel, D. J.; Choe, H., Mechanical behavior of Li-ion-conducting crystalline oxide-based solid electrolytes: a brief review. Ionics 2017, 24 (5), 1271-1276], based on Griffith's fracture criteria for a sharp crack [see Wolfenstine, J.; Allen, J. L.; Sakamoto, J.; Siegel, D. J.; Choe, H., Mechanical behavior of Li-ion-conducting crystalline oxide-based solid electrolytes: a brief review. Ionics 2017, 24 (5), 1271-1276],

$${σ}_{f}^{0} = \frac{{K}_{IC}^{0}}{1.12 \sqrt{π {a}_{C}}} \qquad ( Eq 15 )$$

Crack propagation due to an applied tensile stress, σₐₚₚ, will be mitigated by the compressive stress in the ion exchange layer. For mode I loading (i.e., normal to the faces of the surface crack considered here), this is described by the stress intensify factor:

$${K}_{I}^{IX} ( a ) = ( {σ}_{app} - {σ}_{c} ) \sqrt{π a} . \qquad ( Eq 16 )$$

Fracture is then expected to occur when K_{I}^{IX}(a)=K_{IC}⁰. This relationship can also be used to define an apparent increase in the fracture toughness due to the ion exchange induced residual compressive stress, ΔK_{IC}^{IX}(a)=σ_{c}\sqrt{πa}. The fracture strength in the ion exchange region is then increased by Δσ_{f}^{IX}≈σ_{C} When the ion exchanged thickness is larger than the pre-existing crack length (a<<λ), the fracture strength increment is close to σ_{c}, or the value of the residual stress induced by ion exchange.

In a high-density, well-polished LLZO sample, the grain size serves as a reasonable limiting value for σ_{C}. A wide range of grain sizes have been reported for sintered LLZO, for example 2-5 μm by Cho et al [see Cho, J. H.; Kim, K.; Chakravarthy, S.; Xiao, X.; Rupp, J. L. M.; Sheldon, B. W., An Investigation of Chemo-Mechanical Phenomena and Li Metal Penetration in All-Solid-State Lithium Metal Batteries Using In Situ Optical Curvature Measurements. Advanced Energy Materials 2022, 12 (19), 2200369], and 1-50 μm (depending on the dopant used) by Yu et al [see Yu, S.; Schmidt, R. D.; Garcia-Mendez, R.; Herbert, E.; Dudney, N. J.; Wolfenstine, J. B.; Sakamoto, J.; Siegel, D. J., Elastic Properties of the Solid Electrolyte Li₇La₃Zr₂O₁₂ (LLZO). Chemistry of Materials 2015, 28 (1), 197-206]. Grain sizes from 1-20 μm are considered. At 1200K, the time (˜λ²/2D_{K}) for K⁺ to diffuse through a thickness of 1, 10 (and a hypothetical 100 μm) is on the order of 25 seconds, 0.7 hours (two days). Setting the ion exchange thickness to twice of the grain size, λ=2a_{C} for an electrolyte thickness of 1 mm, this corresponds to an exchange depth ratio (λ/t) of 0.2-4%, confirming a shallow depth approximation.

Using Eq. 15 and 16, the gain in the fracture toughness and fracture strength for two values of C_{K} and grain sizes is estimated. For a 20 μm grain, the increment of fracture strength, Δσ_{f}^{IX}, is 4.32 and 8.64 times of σ_{f}⁰, or the fracture strength of IX-LLZO is 600 MPa and 1,086 MPa, for C_{K}=1.7% and C_{K}=3.4%, respectively. Correspondingly the fracture toughness (K_{IC}^{IX}=K_{IC}⁰+ΔK_{IC}^{IX}) becomes 5.32 and 9.64 MPa·m^{(1/2)} (depending on C_{K}). For small grain/flaw size of ˜1 μm, the K_{IC}^{IX} becomes 1.97 and 2.93 MPa·m^{(1/2)} for C_{K}=1.7% and C_{K}=3.4%, respectively thus exhibiting a significant improvement on fracture toughness.

Ion exchange also creates a tensile zone in the bulk, which may cause catastrophic spontaneous fracture driven by tensile stress [see Martens, R. B. a. R. In Shattering glass cookware, American Ceramic Society Bulletin, 2012; pp 33-38; Karlsson, S., Spontaneous Fracture in Thermally Strengthened Glass—a Review and Outlook. Ceramics—Silikaty 2017, 188-201]. Thus, there exists an upper bound to λ. Considering the bulk region has a fracture strength of 150 MPa, and taking an engineering factor of safety of 2, 75 MPa is set as the highest permissible σ_{T}. Correspondingly, the upper bound for A (using Eq 11) for a t=1 mm thick electrolyte is ˜33 μm, still within a shallow depth approximation.

The previous λ estimates are for typical 1 mm thick LLZO pallets. To increase energy density, it is ideal to reduce the solid electrolyte thickness to hundreds or tens of microns [see Kravchyk, K. V.; Okur, F.; Kovalenko, M. V., Break-Even Analysis of All-Solid-State Batteries with Li-Garnet Solid Electrolytes. ACS Energy Letters 2021, 6 (6), 2202-2207]. At those scales, the ion exchange thickness can be scaled with t. For thin solid electrolytes, the layer thickness is likely to be a significant fraction of t. This will increase σ_{T} inside of the pellet of solid electrolyte (via Eq. 11), and reduce σ_{c} in the surface layer.

The model of ion exchange is based on creating surface layers on both sides of the LLZO (cathode and anode side, as shown schematically in FIG. 6). This will counter bending of the electrolyte and may also help decrease the probability of brittle fracture during battery assembly. However, exchanging both sides is not a necessary requirement. If only one side is exchanged, there will still be a compressive stress of approximately −σ_{c} when t>>λ. However, the pellet will bend, with mild tension in the LLZO just below the surface layer and mild compression on the far side. When the surface layer is a larger fraction of the total thickness (for example, with thinner electrolytes), the bending will relax stress in the surface layer and decrease its magnitude to a value that is lower than σ_{c}. These effects can be readily analyzed with continuum mechanics.

### Example XI

Method for the Ion-Exchange of Lithium with Potassium

Commercially sourced titanium-doped lithium lanthanum zirconium oxide (LLZTO) pellets from Toshima are used for the following process. The as-received product is manually polished using 1200 grit silicon carbide abrasive paper, followed by 3000 and 5000 grit abrasive paper. For each grit, 100 repetitions of a figure-8 pattern are performed for each of the two sides of the LLZTO pellet. It is to be understood that the polishing steps described herein are exemplary in certain embodiments and are not intended to limit the scope of the invention. The pellet is then brought into a glovebox, which has an inert, argon atmosphere. The pellet is put into a boron nitride crucible and placed into the glovebox oven where it is heated to 500° C. in 12 minutes and is held at that temperature for three hours. The oven is then turned off, and the door opened to allow for at least 5-12 hours of cooling. Following removal from the glovebox oven, the pellets are polished again with the 5000 grit polishing paper, though only 10-15 repetitions of the figure-8 pattern are repeated this time. XRD is then performed on the pellet using the sin² ϕ method to determine the residual stress in the pellet prior to the ion exchange process.

For the ion-exchange process, a mortar and pestle are used to grind potassium chloride (KCl) into a fine powder. A boron nitride crucible is filled with the KCl powder such that the layer is 1-2 mm thick. The LLZTO pellet is placed onto the powder, and more powder is added until the top surface of the pellet is no longer visible and is under a 1-2 mm thick layer of KCl powder. The

lid to the boron nitride crucible, also made of boron nitride, is positioned on the crucible. The crucible is then transferred into a tube furnace fitted with a mullite tube. Rubber seals, a vacuum pump, and a feedthrough of ultra high purity argon allows for the evacuation and refill of the tube. This process is repeated three times to achieve an inert atmosphere within the tube furnace, and a constant flow of argon is maintained throughout the experiment. Over the course of 300 minutes, the sample is heated to 800° C. It is held at this temperature for 10 hours. The flow of argon continues while the furnace cools down to 19-35° C. prior to being removed.

Once removed from the furnace, the LLZTO pellet is gently swirled in a 1 molar solution of potassium hydroxide (KOH) in an alumina crucible for 10-30 seconds. This step encourages lithium (Li) ions that may have undergone ion exchange with potassium ions to form lithium hydroxide (LiOH), effectively cleaning the surface. The pellet is then removed from the KOH and sprayed with deionized water for several seconds on each side, to remove any remaining salts on the exterior of the pellet and rinse off any LiOH that may have formed. A KimWipe is used to gently dry the pellet, after which it goes into the glovebox oven where it is heated to 500° C. in 12 minutes and is held at that temperature for one hour. The oven is then turned off, the oven door opened slightly, and the pellet is allowed to cool for 5-12 hours. If the surface of the LLZTO does not appear to be shiny and reflective after this drying process, 5-10 repetitions of a figure-8 pattern on 5000 grit polishing paper are performed. XRD is again performed on the pellet using the sin² ϕ method to determine the residual stress in the pellet after the ion exchange process. The ion-exchanged LLZTO pellet is then tested in an electrochemical cell.

### Example XII

### Analysis of LLZTO Pellets

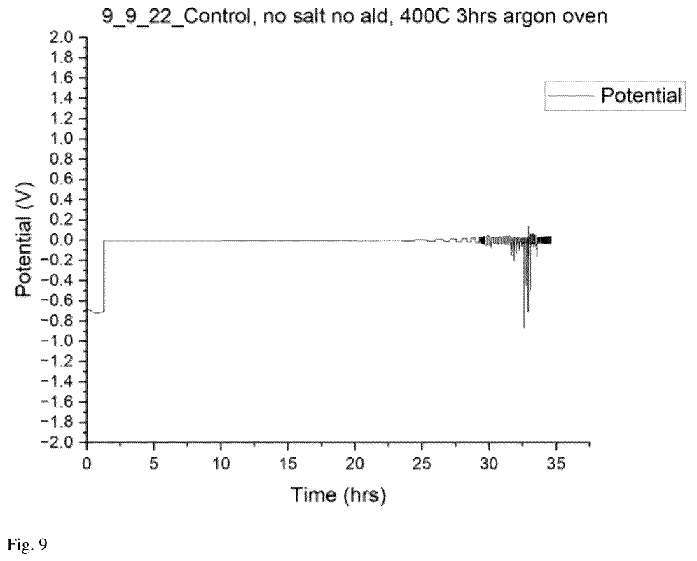

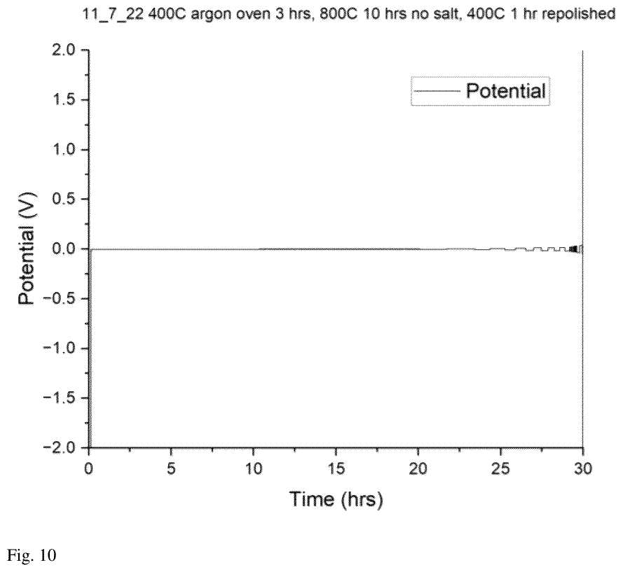

Several baseline LLZTO pellets, that were not ion-exchanged, have been tested with various configurations. FIG. 9 shows electrochemical data for a baseline pellet that was polished using 1200, 3000, and 5000 grit silicon carbide polishing paper, and then heated in the glovebox oven at 400° C. for three hours. It was then tested in a symmetric coin cell with X inch diameter Li foil discs on both sides of the LLZTO pellet, followed by a stainless steel spacer and a wave spring. The critical current density (CCD) was tested by beginning at a current density of 0.025 mA/cm² until a capacity of 0.25 mAh/cm² was reached, and then reversing the direction of the current. The current density was increased in increments of 0.125 mA/cm² until the cell failed.

FIG. 10 shows electrochemical results from another baseline pellet that was prepared in a similar manner as the pellet tested in FIG. 9. However, this pellet was also heated in the tube

furnace to 800° C. for 10 hours followed by a one hour 400° C. heat treatment in the glovebox oven and repolishing with 5000 grit abrasive paper. It was also tested in a quick-assembly split coin cell which allows for more facile characterization of the pellet after characterization.

The third baseline pellet was heat treated at 400° C. for three hours in the glovebox oven. Physical vapor deposition (PVD) was then used to coat 5 nm of gold onto the pellet. A 15-hour heat treatment was then performed in the tube furnace at 800° C. Once the symmetric coin cell was

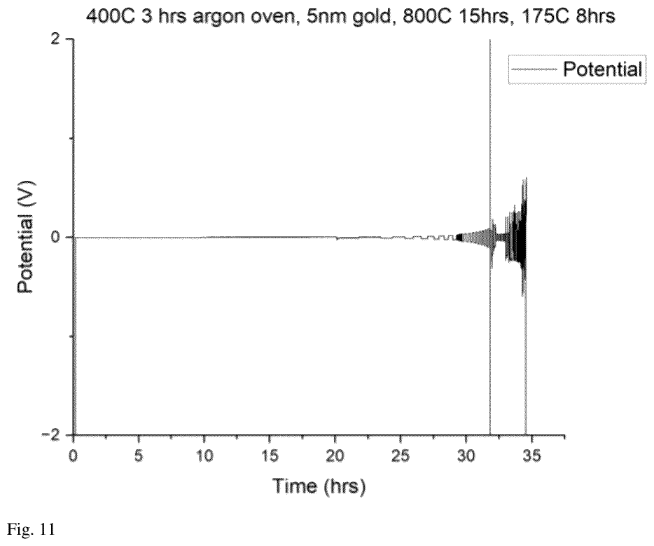

assembled, it was placed into the glovebox oven at 175° C. for eight hours to improve the interfacial contact between the Li and LLZTO pellet. The electrochemical data for this cell is shown in FIG. 11.

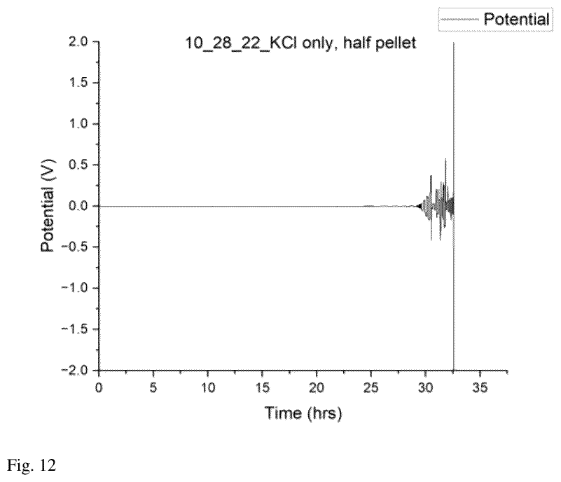

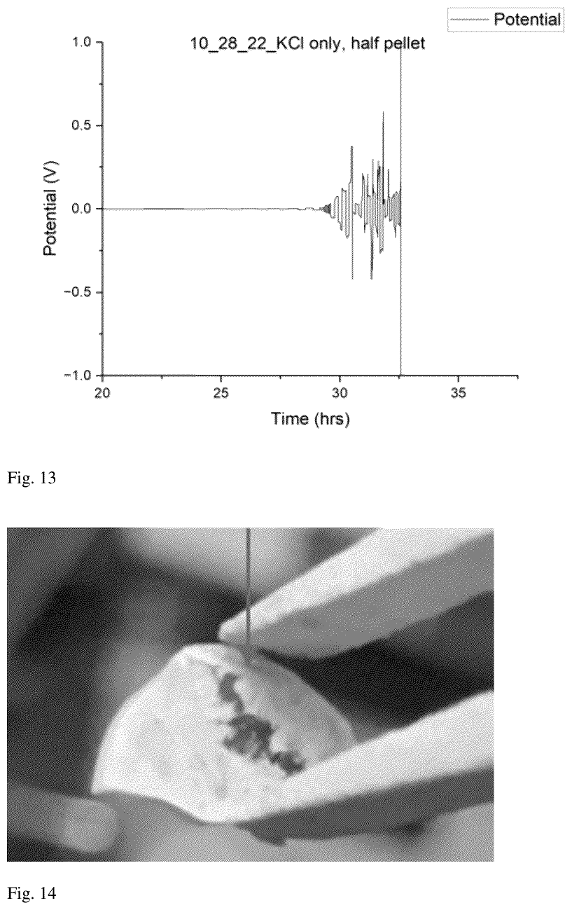

FIG. 12 and FIG. 13 show the electrochemical results for half of an LLZTO pellet that was ion-exchanged with potassium. The pellet was polished using the procedure described earlier, was heated to 400° C. for three hours in the glovebox oven, and then underwent the ion exchange process as described herein with the KCl powder in the tube furnace at 800° C. for 10 hours. It was subsequently rinsed in the 1M KOH solution and DI water, and then dried at 400° C. for 1 hour and repolished with 5000 grit polishing paper. During handling, the pellet broke in half, but one half was still assembled into a symmetric quick-assembly split coin cell with Li foil on either side of the pellet, and stainless-steel spacers on the other side of each Li foil piece. The critical current densities of the described cells, indicative of when the cell failed, are summarized in Table 6 below which is a summary of cell conditions and critical current densities (CCD).

TABLE 6

| Condition | CCD (mA/cm²) |
|---|---|
| 400° C. 3 hr (glovebox), coin cell | 1.525 |
| 400° C. 3 hr (glovebox), 800° C. | 1.525 |
| 10 hrs, 400° C. 1 hr, | |
| re-polished, quick-assembly | |
| split coin cell | |
| 400° C. 3 hr (glovebox), | 2.525 |
| 5 nm gold, 800° C. 15 hrs, | |
| 175° C. 8 hrs, coin cell | |
| 400° C. 3 hr (glovebox), | 1.775 (~3.55 for |
| 800° C. 10 hrs KCl powder, | the whole pellet?) |
| 400° C. 1 hr, re-polished, | |
| quick-assembly split coin cell | |
| (half pellet) | |

As indicated in Table 6, the ion-exchanged LLZTO pellet, with a current density of 1.775 mA/cm², performed better than the baseline pellets with current densities of 1.525 mA/cm². Considering only one half of the ion-exchanged pellet was tested, and thus the active area involved in the current densities was difficult to measure, it is likely that this measurement is an underestimate of the actual critical current density. The baseline pellet that had a 5 nm layer of gold likely performed better due to more uniform current distribution and improved interfacial contact between the coated LLZTO and Li. It is important to note that the cells in Table 6 were cycled symmetrically, meaning current alternated between positive and negative, after reaching a capacity of 0.1-0.25 mAh/cm². This capacity has since been increased in the interest of demonstrating commercially useful batteries as discussed in Example XV.

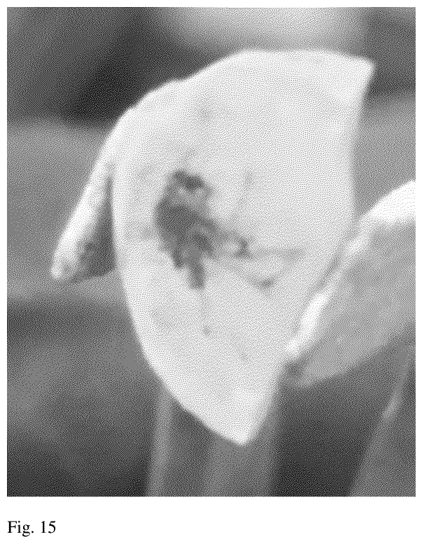

FIG. 14 and FIG. 15 include visual evidence of stress induced at the surface of the ion-exchanged LLZTO pellet. These images were taken after the pellets were polished, and show the Li (the dark area) radiating outwards (laterally) after failing to puncture the surface. Typically, a Li dendrite that has caused a cell to fail appears as a small spot or a thin line that can be observed either by eye or using a scanning electron microscope. The large dark gray area evidences that ion exchange successfully occurred and extended the life of the cell.

### Example XIII

Method for the Ion Exchange of Lithium with Silver

Commercially sourced titanium-doped lithium lanthanum zirconium oxide (LLZTO) pellets from Toshima are used for the following processes. The as-received product is manually polished using 1200 grit silicon carbide abrasive paper, followed by 3000 and 5000 grit abrasive paper. For each grit, 100 repetitions of a figure-8 pattern are performed for each of the two sides of the LLZTO pellet. This process is performed in a glovebox, which has an inert, argon atmosphere.

For pellets being ion-exchanged, AgNO₃ salt sourced from Sigma Aldrich was ground into a fine powder using a mortar and pestle. A polished LLZTO pellet or pellet fragment is placed on a flat surface, usually the boron nitride crucible cover. A metal scoopula is used to transfer <0.1g

AgNO₃ powder onto the pellet, and the bottom of the scoopula is used to press the powder into a flat, uniform layer that is 1-2 mm thick. Using tweezers the pellet is transferred into the boron nitride crucible. If both sides of the pellet are being treated, a 1-2 mm thick layer of AgNO₃ powder is placed into the boron nitride crucible prior to placing the pellet in the crucible. The cover to the crucible is secured, and the system is put into the glovebox oven. The temperature is set to 480° C. for 24 hours. Once the system has cooled to room temperature, the pellets are moved out of the glovebox and into a different boron nitride crucible. This crucible is placed into a tube furnace with a mullite tube. Rubber seals, a vacuum pump, and a feedthrough of ultra high purity argon allows for the evacuation and refill of the tube. This process is repeated three times to achieve an inert atmosphere within the tube furnace, and a constant flow of argon is maintained throughout the experiment. Over the course of 320 minutes, the tube furnace heats up to 960° C. and this temperature is held for 24 hours before cooling naturally to room temperature.

The pellets may be put directly into quick-assembly split coin cells for testing. Alternatively, the pellets may be first characterized using X-ray Diffraction (XRD), scanning electron microscopy (SEM), and electron dispersive spectroscopy (EDS). A solution consisting of two parts water and one part concentrated (15.55 molar) nitric acid can optionally be used as an etchant to remove the silver layer from treated LLZTO pellets.

For control measurements, pellets were placed into a boron nitride crucible with a cover after being polished, and then placed into the glovebox oven at 400° C. for three hours. These pellets

were then put into quick-assembly split coin cells for testing. Some “modified control” pellets were exposed to the same cumulative heat treatment as the ion-exchanged pellets, but the AgNO₃

was added later in the process. This modified treatment involved heating the pellets at 480° C. for

22 hours in the glovebox oven, heating them for 960° C. in the tube furnace, and then adding the

AgNO₃ to the pellet prior to heating them to 480° C. for two hours. In total, the pellet was exposed

to 480° C. for 24 hours and 960° C. for 24 hours but the AgNO₃ was not present during the 960° C. step. “Half treated” pellets refer to pellets that were covered in AgNO₃ and placed into the glovebox oven at 480° C. for 24 hours, but did not undergo a 960° C. step. Several pellets also underwent minimal heat treatment, with only a 2 hour hold at 480° C. after the addition of AgNO₃.

### Example XIV

### Electrochemical Testing: Cell Assembly

All electrochemical testing for AgNO₃ treated pellets and respective baselines have been conducted in quick-assembly split coin cells, which allow for more facile characterization of the pellet compared to traditional coin cells.

Cells are constructed by first scraping the oxide layer off of both sides of thick lithium foil using a metal spatula. The clean lithium foil is then flattened with a heavy, smooth metal disc. The lithium is placed into a plastic bag and a ⅜″ diameter hole punch is used to cut out a disc of lithium. The two plastic pieces on either side are removed. This piece of lithium is pressed onto a stainless-steel spacer that is typically used in coin cells. The spacer and lithium are placed into the base of a quick-assembly split coin cell, with the lithium facing up. The liquid electrolyte used in the assembly of these cells is 0.4M LiNO₃ 0.6M LiTFSl in DOL:DME (1:1). Two to three drops of liquid electrolyte are placed on top of the lithium, followed by a Celgard separator, two more drops of liquid electrolyte, the LLZTO pellet or pellet fragment, another drop of liquid electrolyte and then another lithium disc that is either ¼″ or ⅛″ outer diameter, depending on the size of the pellet fragment. It is the size of this second lithium disc that is relevant when calculating the current density. Thus, the second lithium disc is flattened and punched out twice prior to being placed into the cell to ensure it does not further expand during cell assembly.

### Example XV

### Electrochemical Testing: Critical Current Density (CCD) Testing Procedure

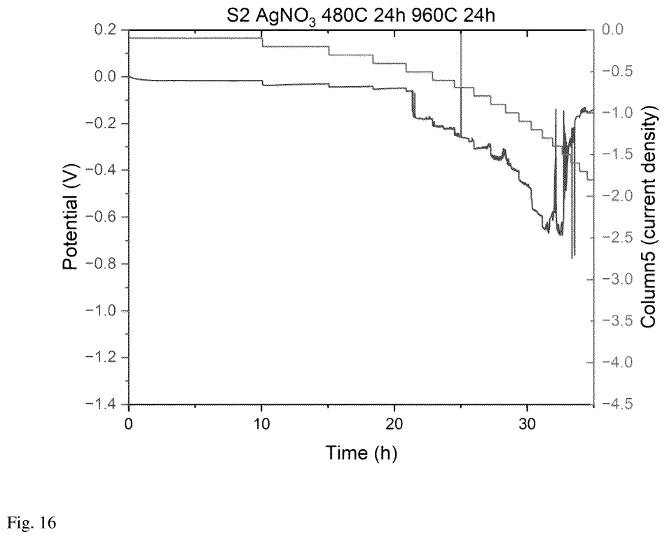

The CCD testing procedure reflects the desired capacity for commercially useful batteries. For CCD tests where only negative current is applied, the current density increases in magnitude by 0.1 mA/cm² every time the capacity of 1 mAh/cm² is reached. See FIG. 16 which is an example of a CCD plot with only negative current being applied to ion-exchanged sample S2 with CCD of 1.4 mA/cm².

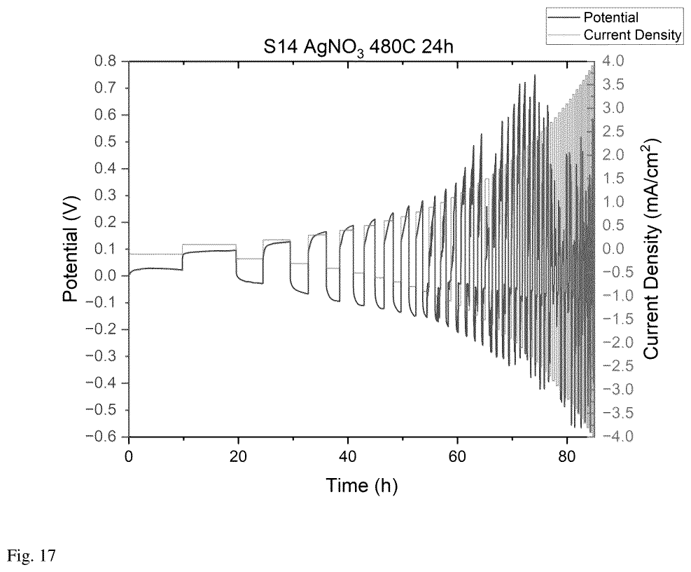

For CCD tests where both positive and negative current is applied, a negative current of 0.1 mA/cm² is applied first until a capacity of 1 mAh/cm² is reached. A positive current of 0.1 mA/cm² is applied next until a capacity of 1 mAh/cm² is reached, and this process continues in increments of 0.1 mA/cm². See FIG. 17 which is an example of a CCD plot with alternating negative and positive current being applied to half treated sample S14 with CCD of 1 mA/cm².

Cell failure is marked by a short-circuit event, typically characterized by a sharp increase in voltage, or a dramatic decrease in the voltage of the cell despite increasing current, indicative of a dendritic failure process.

Table 7 below summarizes the average CCD for control, silver-coated, modified control, half-treated, and treated pellets tested, along with the number of cells tested for each condition.

TABLE 7

| | Number of | Average |
|---|---|---|
| Condition | Cells Tested | CCD (mA/cm²) |
| Control (400C 3 h) | 2 | 0.3 ± 0.1 |
| Silver-Coated (AgNO₃), 480C 2 h) | 3 | 1.03 ± 0.31 |
| Modified Control (480C 22 h, 960 | 2 | 1 ± 0.2 |
| 24 h, AgNO₃, 480 2 h) | | |
| Half-treated (AgNO₃, 480C 24 h) | 1 | 1 |
| Treated (AgNO₃, 480C 24 h, 960C | 6 | 0.85 ± 0.31 |
| 24 h) | | |

Information for each specific cell tested is included in Table 8 below.

TABLE 8

| Sample | | | CCD |
|---|---|---|---|
| Name | Treatment | AgNO₃? | (mA/cm²) |
| C1 | Polished, 400C 3 h | No | 0.4 |
| C2 | Polished, 400C 3 h | No | 0.2 |
| S1 | Polished, 480C 24 h | Yes (one side, | 0.9 |
| | 960C 24 h | prior to 480C | |
| | | treatment) | |
| S2 | Polished, 480C 24 h | Yes (one side, | 1.4 |
| | 960C 24 h | prior to 480C | |
| | | treatment) | |
| S3 | Polished, 480C 24 h | Yes (one side, | 0.4 |
| | 960C 24 h | prior to 480C | |
| | | treatment) | |
| S7 | Polished, 480C 24 h | Yes (one side, | 1 |
| | 960C 24 h | prior to 480C | |
| | | treatment) | |
| S8 | Polished, 480C 24 h | Yes (one side, | 0.6 |
| | 960C 24 h | prior to 480C | |
| | | treatment) | |
| S9 | Polished, 480C 24 h | Yes (one side, | 0.8 |
| | 960C 24 h | prior to 480C | |
| | | treatment) | |
| S14 | Polished, 480C 24 h | Yes (one side, | |
| | | prior to 480C | |
| | | treatment) | |
| S15 | Polished. 480C 2 h | Yes (one side, | 1.3 |
| | | prior to 480C | |
| | | treatment) | |
| S16 | Polished, 480C 2 h | Yes (one side, | 1.2 |
| | | prior to 480C | |
| | | treatment) | |
| S17 | Polished, 480C 2 h | Yes (one side, | 0.6 |
| | | prior to 480C | |
| | | treatment) | |
| S33 | Polished, 480C 22 h, | Yes, only prior | 0.8 |
| | 960C 24 h, | to last 480C | |
| | 480C 2 h | 2 h step (control) | |
| S32 | Polished, 480C 22 h, | Yes, only prior | 1.2 |
| | 960C 24 h | to last 480C | |
| | 480C 2 h | 2 h step (control) | |
| S42 | Nitric acid exposure, | No | 0.8 |
| | 200C hot | | |
| | plate 1 min/side | | |

The data demonstrates that the addition of AgNO₃ improves CCD from the baseline value of 0.3±0.1 mA/cm². The proposed ion-exchanged process improves average CCD to 0.85±0.31 mA/cm², while the addition of a silver film from the thermal decomposition of AgNO₃

also seems to improve CCD to values around 1 mA/cm². Among the three average CCD values shown above for AgNO₃ treated pellets, the category with the lowest average, 0.85±0.31 mA/cm² is also the treatment that resulted in the highest measured CCD in these experiments (1.4 mA/cm²) evidencing treatment to result in successful ion-exchange based on theory and residual stress measurements using XRD sin² ϕ method.

It is to be understood that different procedures for potassium and ions and silver ions describe herein result in different values for CCD, but that each of potassium ions and silver ions produced beneficial electrochemical results.

### Example XVI

Residual Stress Measurements Using XRD sin²ψ Method

A Bruker D8 Discovery XRD machine and the sin² ϕ method is used to determine the residual stress in LLZTO pellets. The sin² ϕ method measures the change in lattice spacing for a chosen XRD peak as the sample is incrementally rotated. Increases in d-spacing correspond to the material being in tension, while decreases in lattice spacing correspond to compression. Beginning with the sample flat (0=0°), three measurements are made with a time of 60-120 seconds per frame. Measurements are repeated to account for machine error in measurement. The psi angle is increased to 45° in increments of 9°, with three measurements taken at each increment. The average d-spacing, in angstroms, is plotted against each psi value, in radians. The equation for the linear fit of the data provides information about the strain experienced by the material. Combined with the Young's modulus and Poisson's ratio for LLZTO, the stress can be calculated.

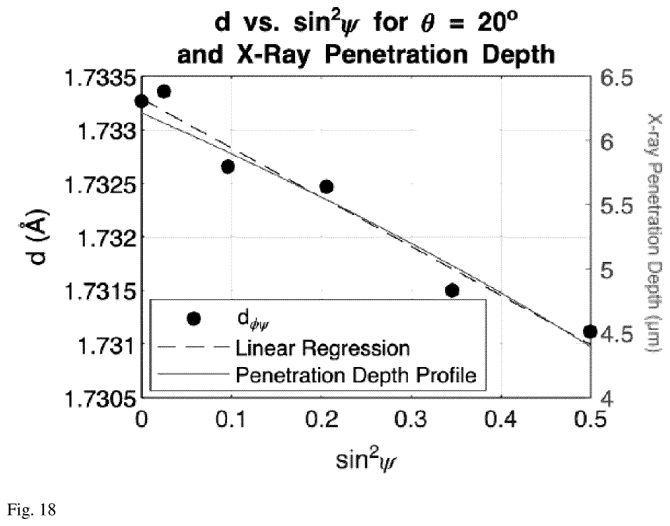

Pellets not treated with AgNO₃ tend to have residual compressive stress of around −100 MPa to −350 MPa. An example of a pristine pellet measurement is shown in FIG. 18.

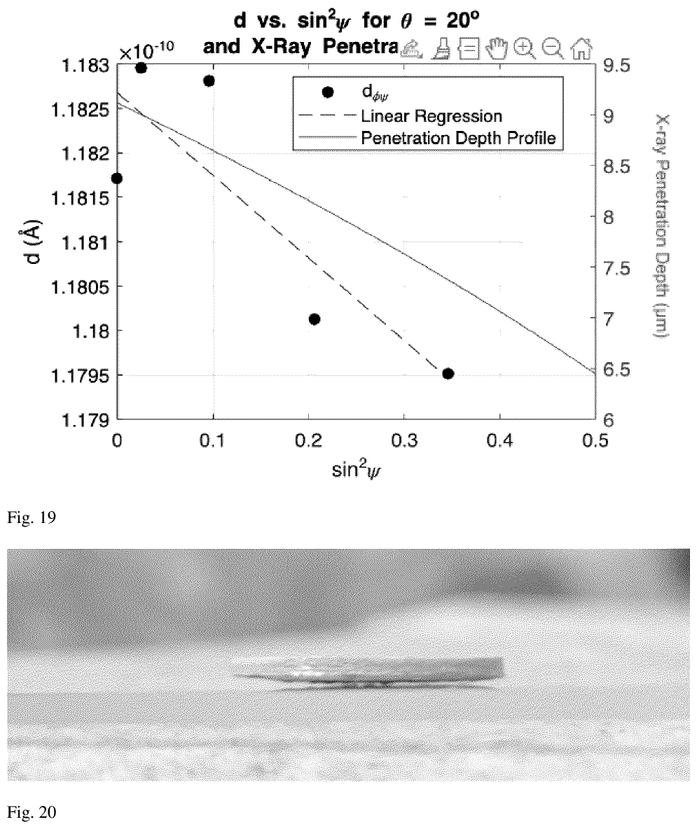

Dramatic changes in residual stresses in the pellet have been observed after treatment with AgNO₃. An example of such stresses are shown in FIG. 19 with sample S41. One side of S41 was covered in AgNO₃ prior to undergoing the 480° C. 24 hour, 960° C. 24 hour ion-exchange process.

The stresses in S41 were so large that they could be seen optically without any additional

magnification instruments. The image in FIG. 20 was taken using an iPhone and shows the curvature introduced to the LLZTO pellet after the ion-exchange process.

1. A method of providing residual compressive stress to a lithium-based solid electrolyte comprising
subjecting the lithium-based solid electrolyte to ion exchange conditions where lithium ions within the lithium-based solid electrolyte are exchanged with ions in a sub surface region of the lithium-based solid electrolyte so as to impart residual compressive stresses in the sub-surface region of the lithium-based solid electrolyte,
wherein the ions have a larger ionic radius than the lithium ions.

2. The method of claim 1 wherein the ions are members of the group consisting of potassium ions, silver ions, sodium ions, and calcium ions and mixtures thereof.

3. The method of claim 1 wherein lithium ions are exchanged with ions having a larger ionic radius than the lithium ions in an amount to allow sufficient lithium ion diffusion for performance of the solid state electrolyte in a solid-state battery.

4. The method of claim 1 wherein the ions are potassium ions.

5. The method of claim 1 wherein between 2% and 5% lithium ions of the lithium-based solid electrolyte are exchanged with potassium ions.

6. The method of claim 1 wherein between 3% and 4% lithium ions of the lithium-based solid electrolyte are exchanged with potassium ions.

7. The method of claim 1 wherein 3.4% lithium ions of the lithium-based solid electrolyte are exchanged with potassium ions.

8. The method of claim 1 wherein the lithium-based solid electrolyte comprises lithium lanthanum zirconium oxide.

9. The method of claim 1 wherein the lithium-based solid electrolyte is contacted with a source of ions and heated to a temperature sufficient to promote exchange of lithium ions of the lithium-based solid electrolyte with ions of the source of ions.

10. The method of claim 1 wherein the residual compressive stresses inhibit dendrite formation in the lithium-based solid electrolyte.

11. The method of claim 1 wherein the subsurface region is at least 40 microns deep from the surface of the lithium-based solid electrolyte.

12. The method of claim 1 wherein the subsurface region is at least 20 microns deep from the surface of the lithium-based solid electrolyte.

13. The method of claim 1 wherein the ion exchange depth ratio is 0.2% to 4% of the thickness of the lithium-based solid electrolyte.

14. The method of claim 1 wherein lithium ions diffuse out of the lithium-based solid electrolyte and the ions from a source of ions diffuse into the lithium-based solid electrolyte.

15. The method of claim 1 wherein the ions are silver ions.

16. The method of claim 1 wherein the ions are monovalent or divalent cationic ions.

17. A lithium-based solid electrolyte comprising diffused potassium ions or diffused silver ions.

18. The lithium-based solid electrolyte of claim 17 wherein the amount of diffused potassium ions or diffused silver ions allow sufficient lithium ion diffusion for performance of the solid-state electrolyte in a solid-state battery.

19. The lithium-based solid electrolyte of claim 17 comprising lithium lanthanum zirconium oxide.

20. The lithium-based solid electrolyte of claim 17 having a higher residual compressive stress compared to a lithium-based solid electrolyte lacking diffused potassium ions or diffused silver ions.

21. The lithium-based solid electrolyte of claim 17 resistant to dendrite formation.

22. A solid-state battery comprising the lithium-based solid electrolyte of claim 17.
